(19) United States
(12) Patent Application Publication
(10) Pub. No.: US 2007/0229648 A1
(43) Pub. Date: Oct. 4, 2007

(54) EXPOSURE DEVICE AND IMAGE FORMING APPARATUS USING THE SAME

(75) Inventors: Kenichi Masumoto, Osaka (JP); Hiroshi Shirouzu, Fukuoka (JP); Tetsurou Nakamura, Hyogo (JP); Kei Sakanoue, Fukuoka (JP); Yuuji Toyomura, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/693,189

(22) Filed: Mar. 29, 2007

(30) Foreign Application Priority Data
Mar. 31, 2006 (JP) 2006-100412
Mar. 31, 2006 (JP) 2006-100413
Mar. 31, 2006 (JP) 2006-100414
Mar. 31, 2006 (JP) 2006-100415

(51) Int. Cl. B41J 2/45

(52) U.S. Cl. 347/238

(57) ABSTRACT

To provide an exposure device which is capable of controlling light intensity with high precision by improving reliability of light intensity detection, and an image forming apparatus using the same, an exposure device includes a light emitting device array having a plurality of organic electroluminescence devices 110 arranged on a substrate, a light detecting device 120 that detects light emitted from the organic electroluminescence devices 110, and a light intensity detecting circuit C that processes an output of the light detecting device 120. The light intensity detecting unit C includes a capacitive element 140 connected to the light detecting device 120 and a select transistor 130 that is connected to the capacitive element 140 and draws out charges accumulated in the capacitive element 140. The select transistor 130 and the light detecting device 120 are isolated from each other with the capacitive element 140 interposed therebetween.

### BACKGROUND OF THE INVENTION

1. Field of the Invention

The present invention relates to an exposure device and an image forming apparatus using the exposure device, and more specifically, to an exposure device provided with a row of light emitting devices arranged in the form of a line, and an image forming apparatus using the exposure device.

2. Description of the Related Art

As exposure systems used in image forming apparatuses adopting an electrophotographic process, there have been known a system of forming an electrostatic latent image on a photoconductor by scanning the photoconductor with light beam, which is emitted from a laser diode as a light source, through a rotating polygonal rotating mirror (abbreviated as a polygon mirror), and a system of forming an electrostatic latent image on a photoconductor by individually controlling switching on/off of light emitting diodes (LEDs) or light emitting devices, which are made of organic electroluminescence material and form a row of light emitting devices arranged in the form of a line.

Particularly, since an exposure device equipped with organic electroluminescence devices as light emitting devices can integrally form a driving circuit, which is constituted by switching elements such as thin film transistors (TFTs), and the organic electroluminescence devices on a substrate made of, for example, glass, it can realized with a simple structure and manufacturing process and with smaller size and lower production costs than an exposure device equipped with LEDs as light emitting devices.

On the other hand, it has been known that an organic electroluminescence device shows a so-called light intensity deterioration effect that luminance gradually decreases with driving time. In addition, since it is difficult to prevent luminance unbalance from occurring between individual organic electroluminescence devices, there is a need of light intensity correction for prevention of light intensity unbalance between individual organic electroluminescence devices.

Due to such various factors, there is a need of light intensity correction of light emitted from individual organic electroluminescence devices.

In connection with the light intensity correction, an example of conventional image forming apparatuses quipped with an exposure device that adopts organic electroluminescence devices is disclosed in Patent Document 1. The exposure device disclosed in Patent Document 1 has the configuration in which a light detecting device is arranged on a glass substrate on which organic electroluminescence devices are formed, and the intensity of light emitted from the organic electroluminescence devices is detected by the light detecting device.

Patent Document 1: Japanese Unexamined Patent Application Publication No. 2004-082330

There is an increasing need of miniaturization of such an image forming apparatus. To meet this need, it is effective to decrease a size of an exposure device of the image forming apparatus. However, in order to decrease the size of the exposure device, there is a need to decrease a size of a substrate on which an exposure light source is formed.

However, in order to unite a light emitting function and light receiving function on a substrate which is arranged in the exposure device and is made of, for example, glass, that is, in order to decrease the size of the exposure device, light emitting devices, a light detecting device and a select circuit that propagates output from the light detecting device have to be adjacent to each other. This may raise a problem in that a malfunction is likely to occur as transistors as switching elements constituting the select circuit receive light, thereby flowing photoelectric conversion current.

### SUMMARY OF THE INVENTION

In light of such circumstances, it is an object of the invention to provide an exposure device which is capable of controlling light intensity with high precision by improving reliability of light detection.

According to an aspect of the invention, there is provided an exposure device including: a substrate; a light emitting device array including a plurality of light emitting devices arranged on the substrate; a light detecting device that detects light emitted from the light emitting devices; a switching device that selects the light detecting devices and draws out an output from the light detecting devices; and a light shielding unit interposed between the light detecting devices and the switching device.

With the above configuration of the exposure device of the invention, since a select transistor as the switching device is isolated by a capacitive element as the light shielding part from the light detecting device, and the capacitive element is formed in such a manner that two or more electrode layers face each other with an interlayer insulating film interposed therebetween, it is possible to provide high light shielding property and prevent stray light reliably, thereby preventing a malfunction, and it is possible to detect light intensity with high precision and high reliability by detecting minute photoelectric current efficiently.

### BRIEF DESCRIPTION OF THE DRAWINGS

FIG. 1 is a top view of organic electroluminescence devices and related peripheral components which constitute an exposure device according to a first embodiment of the invention.

FIG. 2A is a sectional view showing a configuration in the neighborhood of a light detecting device according to the first embodiment of the invention, FIG. 2B is a sectional view showing a configuration in the neighborhood of a capacitive element according to the first embodiment of the invention, and FIG. 2C is a sectional view showing a configuration in the neighborhood of a select transistor according to the first embodiment of the invention.

FIG. 3 is a circuit diagram of a light intensity detecting circuit and a processing circuit equipped in the exposure device according to the first embodiment of the invention.

FIG. 4 is an explanatory view illustrating a relationship between a gate voltage and drain current of the light detecting device according to the first embodiment of the invention.

FIG. 5 is a timing chart showing a timing of light intensity detection according to the first embodiment of the invention.

FIG. 6 is a view showing a configuration of an image forming apparatus according to a second embodiment of the invention.

FIG. 7 is a view showing a configuration in the neighborhood of a developing station in the image forming apparatus according to the second embodiment of the invention.

FIG. 8 is a view showing a configuration of an exposure device in the image forming apparatus according to the second embodiment of the invention.

FIG. 9A is a top view of a glass substrate related to the exposure device in the image forming apparatus according to the second embodiment of the invention, and FIG. 9B is an enlarged view of a main portion of the glass substrate.

FIG. 10 is a block diagram showing a configuration of a controller in the image forming apparatus according to the second embodiment of the invention.

FIG. 11 is an explanatory view illustrating contents of a light intensity correction data memory in the image forming apparatus according to the second embodiment of the invention.

FIG. 12 is a block diagram showing a configuration of an engine controller in the image forming apparatus according to the second embodiment of the invention.

FIG. 13 is a circuit diagram of the exposure device in the image forming apparatus according to the second embodiment of the invention.

FIG. 14 is an explanatory view illustrating a current program period and an organic electroluminescence device lightening on/off period related to the exposure device in the image forming apparatus according to the second embodiment of the invention.

FIGS. 15A and 15B are explanatory views illustrating examples of device arrangement in an exposure device according to a third embodiment of the invention.

FIGS. 16A to 16C are explanatory views illustrating examples of device arrangement in an exposure device according to a fourth embodiment of the invention.

FIG. 17 is a sectional view of a main portion of an exposure device according to a fifth embodiment of the invention.

FIGS. 18A to 18C are explanatory views illustrating a manufacturing process of the exposure device according to the fifth embodiment of the invention.

FIG. 19 is a top view of mother glass according to the fifth embodiment of the invention.

FIG. 20 is a top view of mother glass according to the fifth embodiment of the invention.

### DETAILED DESCRIPTION OF THE PREFERRED EMBODIMENTS

Hereinafter, preferred embodiments of the invention will be described with reference to the accompanying drawings.

### First Embodiment

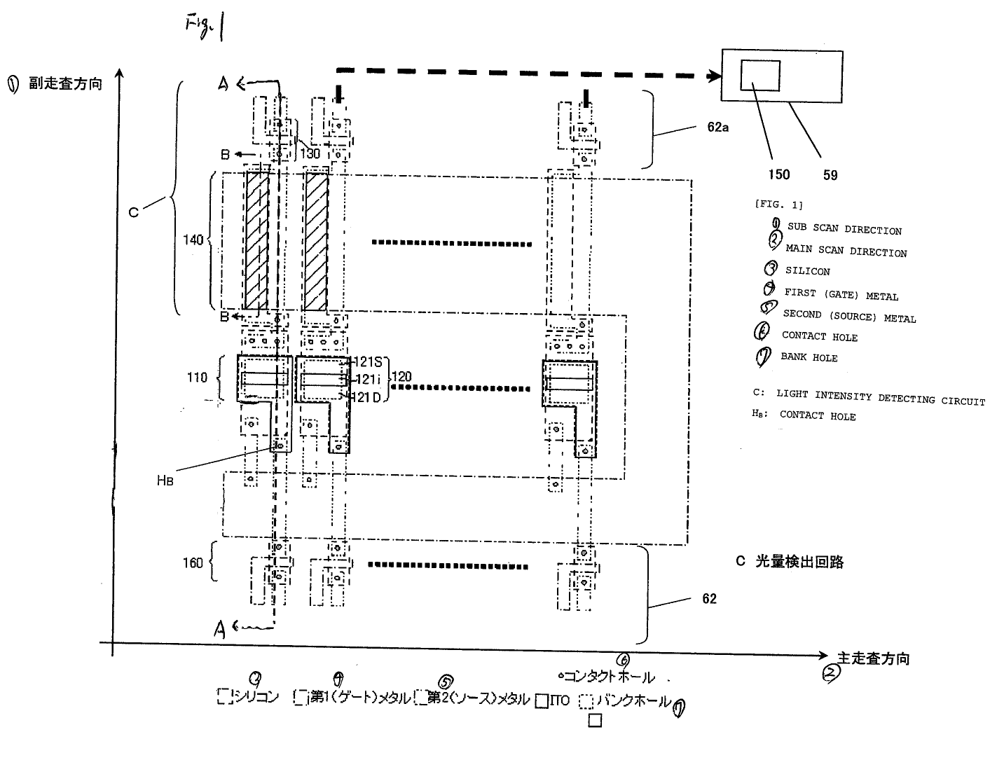

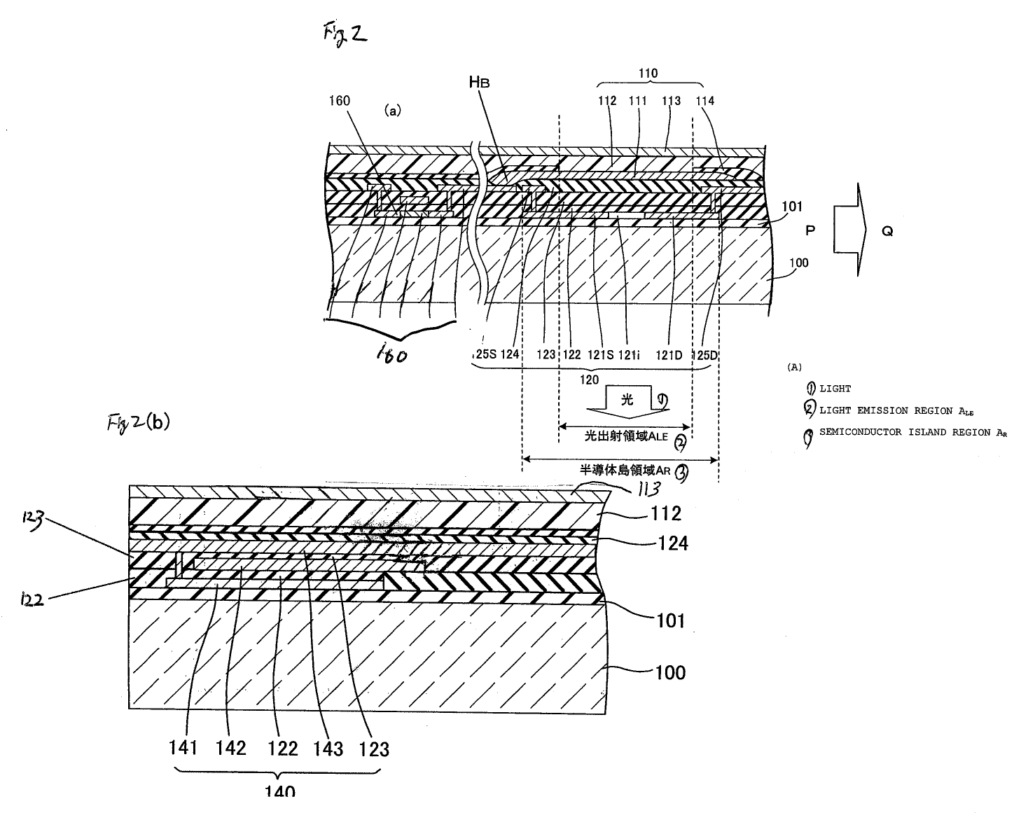

FIG. 1 is a top view of organic electroluminescence devices and related peripheral components which constitute an exposure device according to a first embodiment of the invention, FIG. 2A is a sectional view showing a configuration in the neighborhood of light detecting devices 120 according to the first embodiment of the invention, FIG. 2B is a sectional view showing a configuration in the neighborhood of capacitive elements 140 according to the first embodiment of the invention, and FIG. 2C is a sectional view showing a configuration in the neighborhood of select transistors 130 according to the first embodiment of the invention.

In addition, FIGS. 2A and 2C show an A-A section of FIG. 1 and FIG. 2C shows a B-B section of FIG. 1. In addition, a portion Q in FIG. 2C is provided on an extension line of a portion P in FIG. 2A.

Hereinafter, a configuration of organic electroluminescence devices and related peripheral components which constitute an exposure device according to a first embodiment of the invention will be described with reference to FIGS. 1, 2A, 2B and 2C.

The exposure device is provided with a glass substrate 100 on which an exposure light source is formed.

A light emitting device array constituted by a plurality of light emitting devices (organic electroluminescence devices 110) is formed on a glass substrate 100 of the exposure device. Light detecting devices 120 which detect light emitted from the organic electroluminescence devices 110 are provided along the light emitting device array (FIG. 1 shows a state in which the organic electroluminescence devices 110 overlap the light detecting devices 120). In addition, select transistors 130 as switching devices which select the light detecting devices 120 and take output out of the light detecting devices 120, as will be described later, are formed on the glass substrate 100. Also, capacitive elements 140 as light shielding parts are provided between the select transistors 130 as the switching devices and the light detecting devices 120.

The capacitive elements 140 as the light shielding parts prevent light emitted from the organic electroluminescence devices 110 from being incident into the select transistors 130, thereby effectively preventing malfunction or instable operation of the select transistors 130.

A shown in FIG. 1, the capacitive elements 140 as the light shielding parts and the select transistors 130 as the switching devices are provided in the outside of emission regions (light exit regions, which will be described later) of the organic electroluminescence devices 110 as the light emitting devices or along the light emitting device array, and an area occupied by the capacitive elements 140 and the select transistors 130 are larger than an area occupied by the organic electroluminescence devices 110.

An exposure device may be smaller in the number of light emitting devices than a display apparatus, so the exposure device has an empty space in a region perpendicular to an arrangement direction of the light emitting device array. The capacitive elements 140 and the select transistors 130 can be arranged in the empty space with a margin, that is, without scarifying an electrical characteristic, for example, capacitance.

Hereinafter, the above-described configuration will be described in more detail.

On the glass substrate 100 of the exposure device are formed a device array constituted by the plurality of organic electroluminescence devices 110 as light emitting devices (hereinafter referred to as “light emitting device array”), which is arranged in a main scan direction, the light detecting devices 120 constituted by photodiodes that detect light emitted from the organic electroluminescence devices 110, a light intensity detecting part that is connected to output terminals of the light detecting devices 120 and processes outputs of the organic electroluminescence devices 110 (hereinafter referred to as “light intensity detecting circuit C”), a light intensity calculating circuit 150 that calculates light intensity based on an output of the light intensity detecting circuit C, and a driving circuit 160 that controls driving of the organic electroluminescence devices 110.

In addition, in the first embodiment, the light intensity detecting circuit C includes the select transistors 130 formed of TFTs to construct a TFT circuit 62a. The driving circuit 160 is also formed of TFTs to construct a TFT circuit 62. In addition, the light detecting devices 120 are also formed of TFTs.

The light intensity detecting circuit C includes at least the capacitive elements 140 connected in parallel to the light detecting devices 120, and the select transistors 130 for switching that are connected to the capacitive elements 140 and control read of the capacitive elements 140. Here, the select transistors 130 and the light detecting devices 120 are isolated from each other with the capacitive elements 140 therebetween. In addition, the select transistors 130, the capacitive elements 140 and the light detecting devices 120 are arranged in order in a direction perpendicular to the light emitting device array (a sub scan direction). The select transistors 130 are connected to a processing circuit 59 including the light intensity calculating circuit 150 (hereinafter referred to as “charge amplifier 150”).

An output of the light intensity detecting circuit C, which is selected by one of the select transistors 130, is inputted to the processing circuit 59 including the charge amplifier 150. This output is converted into light intensity measurement data in the processing circuit 59.

In addition, the driving circuit 160 constituting a driving part of the organic electroluminescence devices 110 is formed of TFTs for switching that are formed of polycrystalline silicon layer, and drives the organic electroluminescence devices 110 based on a driving current value set by a driving IC chip (not shown in these figures) (a source driver 61 which will be described later with reference to FIG. 9).

In addition, as shown in FIG. 2A, a light detecting device 120 is formed of a TFT having a first electrode (positive pole 111), which is located at a side of a light detecting device 120 of an organic electroluminescence device 110 as a light emitting device, as a gate electrode. In addition, the light emitting device 120 is comprised of a polycrystalline silicon layer formed by the same process as a select transistor 130 for switching (see FIG. 2C) that selects a timing at which light intensity read of the light intensity detecting circuit C is selected. While a TFT for detecting the light intensity (the light intensity device 120) and a switching TFT for selecting a signal (the select transistor 130) are formed on the same layer with good workability, the select transistor 130 is isolated from the light detecting device 120 by an arrangement space of a capacitive element 140, and accordingly, it is possible to prevent a malfunction due to variation of a threshold value due to incidence of light into the switching TFT (the select transistor 130). In addition, as shown in FIG. 2B, since the capacitive element 140 has a stacked structure in which three electrode layer are stacked with interlayer insulating films interposed therebetween, respectively, high light shield property can be obtained and stray light can be reliably prevented, thereby preventing a malfunction, and it is possible to detect light intensity with high reliability and high precision by detecting minute photoelectric current efficiently.

On a macroscopic point of view, it can be said that FIG. 1 shows the configuration in which the light intensity detecting circuit C is isolated from the driving circuit 160 with the light emitting device array comprised of the organic electroluminescence devices 110 interposed therebetween. This configuration makes it possible to isolate the light intensity detecting circuit C, which deals with minute current, from the driving circuit 160 which deals with relatively large current, thereby making it possible to detect light intensity with high precision without being affected by noises.

In other words, in general, with increase of a degree of integration, although it is difficult to increase the detection precision of light intensity due to unbalance of output current of the light detecting devices 120, which is caused by potential variation of the driving circuit 160 that drives the organic electroluminescence devices 110, the above-described configuration makes it possible to sufficiently secure a S/N ratio when the light intensity is detected.

As described above, it is preferable to isolated the light intensity detecting circuit C from the driving circuit 160 with the light emitting device array comprised of the organic electroluminescence devices 110 interposed therebetween. At this time, it is preferable to draw out driving signal lines, which drive the organic electroluminescence devices 110, and output signal lines, which draw outputs out of the light detecting devices 120, to different sides. From a standpoint of noise-tolerance, it is more preferable to draw out the driving signal lines and the output signal lines in such a manner that these lines get way from the light emitting device array.

In addition, considering a detailed configuration of the organic electroluminescence devices 110, it can be said that the above-described configuration is such that the organic electroluminescence device 110 as the light emitting device having the first electrode (positive pole 111) and a second electrode (negative pole 113) with a light emitting layer interposed therebetween overlaps with the light detecting device 120 having a photo-electric converting layer that detects light emitted from the organic electroluminescence device 110, and the driving part (the driving circuit 160) including a driving transistor connected to the first or second electrode of the organic electroluminescence device 110 is isolated from the light intensity detecting part (the light intensity detecting circuit C) connected to an output of the light detecting device 120 with the light emitting device array interposed therebetween.

As shown in FIGS. 2A, 2B and 2C, the exposure device of the first embodiment comprises the glass substrate 100 on which a base coat layer 101 for surface planarization is formed, the light detecting device 120 and the organic electroluminescence device 110 which are stacked in order on the glass substrate 100, and the TFT (switching transistor) as the driving circuit 160 that is formed on the glass substrate 100 and drives the organic electroluminescence device 110 while correcting driving current or driving time. In addition, the source driver 61 (not shown in these figures) (see FIG. 9) as the IC chip connected to the driving circuit 160 is loaded on the glass substrate 100.

The light detecting device 120 comprises a source region 121A and a drain region 121D, which are formed by doping an island region A_{R}, which is constituted by a polycrystalline silicon layer formed on a surface of the base coat layer 101, with impurities at a desired concentration, with a channel region 121i, which is constituted by a band-shaped i layer, interposed between the source region 121A and the drain region 121D, and source and drain electrodes 125S and 125D formed via a through-hole to pass through a first insulating film 122 and a second insulating film 123, which are constituted by silicon oxide films formed on the source region 121S, the drain region 121D and the channel region 121i. In addition, the organic electroluminescence device 110 is formed on the second insulating film 123 and the source and drain electrodes 125S and 125D via a silicon nitride film as a passivation layer 124. The organic electroluminescence device 110 includes an ITO (Indium Tin Oxide) layer 111 as the first electrode (positive pole), a pixel restricting portion 114 that restricts a light emission region A_{LE}, a light emitting layer 112, and the negative pole 113 as the second electrode, which are stacked in order on the passivation layer 124.

In addition, as shown in FIGS. 2B and 2C, a capacitive element 140 is comprised of a condenser including a first layer electrode 141 formed of a polycrystalline silicon layer, a second layer electrode 142 formed by the same process as a gate electrode 133 of the select transistor 130, the first insulating film 122 interposed between the first and second layer electrodes 141 and 142, a third layer electrode 143, and the second insulating film 123 interposed between the second and third layer electrodes 142 and 143.

That is, the capacitive element 140 is comprised of the first layer electrode 141, the second layer electrode 142, the third layer electrode 143, which are made of conductive material, the first insulating film 122 and the second insulating film 123. Since these three-layered electrodes overlap with each other, they act as a three-layered light shielding film when they are made of light shielding material such as metal. In addition, since each of these layers can be formed by the same process as a source-drain region and a gate electrode of the TFT constituting the select transistor 130, it is possible to simplify a process of manufacturing the capacitive element 140. In addition, by using conductive material having desired light shielding property, the capacitive element 140 may be formed by a process different from the process of forming the select transistor 130.

In addition, layers constituting the select transistor 130 are formed by the same process as layers constituting the light detecting device 120. That is, a source region 132S and a drain region 132D of the select transistor 130 with a channel region 132D interposed between the source region 132S and the drain region 132D are formed by the same process as a semiconductor island of the light detecting device 120. A source electrode 134S and a drain electrode 134D contacting the source region 132S and the drain region 132D, respectively, are stacked on the source region 132S and the drain region 132D, respectively. The source region 132S, the drain region 132D, the source electrode 134S, the drain electrode 134D and the gate electrode 133 form the TFT as the select transistor 130.

These layers are formed through typical semiconductor manufacturing processes including formation of a semiconductor thin film by a CVD method, patterning by a photolithography method, implantation of impurity ions, formation of insulating films, etc.

In this embodiment, the glass substrate 100 is made of colorless and transparent glass. An example of the glass substrate 100 may include inorganic glass such as inorganic oxide glass, inorganic fluoride glass or the like, for example, transparent or translucent soda-lime glass, barium•strontium-containing glass, lead glass, aluminosilicate glass, borosilicate glass, barium-borosilicate glass, quartz glass, etc.

Other materials may be employed as a substitute for the glass substrate 100. For example, the substitutes may include polymer films made of polymer material such as transparent or translucent polyethyleneterephthalate, polycarbonate, polymethylmetacrylate, polyethersulfone, polyvinyl fluoride, polypropylene, polyethylene, polyacrylate, amorphous polyolefine, fluoro-resin polysiloxane, polysilane and the like, chalcogenide glass such as transparent or translucent As₂S₃, As₄₀S₁₀, S₄₀Ge₁₀ and the like, metal oxide and nitride such as ZnO, Nb₂O, Ta₂O₅, SiO, Si₃N₄, HfO₂, TiO₂ and the like, semiconductor material such as opaque silicon, germanium, silicon carbide, gallium-arsenic, gallium nitride and the like (if light emitted from a light emitting region is drawn out without passing through a substrate), the above-mentioned transparent substrate material including pigment and the like, metal material whose surface is subjected to an insulating treatment, etc., or a stack substrate having a plurality of substrate layers stacked each other. Alternatively, the substitute for the glass substrate 100 may include a substrate whose surface is subjected to an insulating treatment, for example, a conductive substrate that is made of metal such as Fe, Al, Cu, Ni, Cr or an alloy thereof and has a surface on which an insulating film is formed by an inorganic insulating material such as SiO₂, SiN or the like or an organic insulating material such as a resin coating material.

In addition, a circuit comprised of resistors, condensers, inductors, diodes, transistors and so on to drive the organic electroluminescence device 110 may be integrated on or inside the glass substrate 100, which will be described later.

In addition, depending on its use purpose, the glass substrate 100 may be made of a material through which only light having a particular wavelength passes or a material that converts light having a particular wavelength into light having a different wavelength. In addition, the glass substrate 100 has preferably insulating property, but, without being limited thereto, may have conductivity as long as it does not disturb the driving of the organic electroluminescence device 110.

The base coat layer 101 is formed on the glass substrate 100. The base coat layer 101 is comprised of, for example, two layers, that is, a first layer made of SiN and a second layer made of SiO₂. It is preferable that these SiN and SiO₂ layers are formed by a sputtering method although they may be formed by other methods such as a deposition method and so on.

The above-described select transistor 130 and light detecting device 120 are formed on the base coat layer 101 using a polycrystalline silicon layer formed by the same process. Although the driving circuit 160 of the organic electroluminescence device 110 is comprised of a circuit element such as a resistor, a condenser, an inductor, a diode, a transistor and so on, it is preferable to use a TFT in consideration of miniaturization of the exposure device. In the first embodiment, as shown in FIG. 2B, the light emitting device 120 is located between the organic electroluminescence device 110 including the light emitting layer 112 and the glass substrate 100 as a light emission surface, and a device region A_{R} having an island shape of the light detecting device 120 (hereinafter referred to as a semiconductor island region A_{R}) is larger than a light emission region A_{LE}. In addition, since the light emission region A_{LE} exists inside the light detecting device 120, a material that does not pass light can not be used for the light detecting device 120. Accordingly, in order not to disturb light emitted from the light emitting layer 112, a transparent material has to be used for the light emitting device 120. For example, it is preferable that polycrystalline silicon is selected as a material of the light detecting device 120.

In the first embodiment, after the same semiconductor layer is formed on the base coat layer 101, the select transistor 130 and the light detecting device 120 are formed as a same layer by etching the semiconductor layer. A process of collectively forming metal layers of the select transistor 130 and the light detecting device 120, which are isolated from each other and have an island shape, from a same metal layer is advantageous to reduction of the number of manufacturing processes and suppression of production costs. In addition, in the light detecting device 120, the semiconductor island region A_{R} that receives the light emitted from the light emission region A_{LE} is a surface of a polycrystalline silicon layer or an amorphous silicon layer having an island shape which becomes the light detecting device 120.

Although the first insulating film 122, the second insulating film 123 and the passivation film 124, which are formed of, for example, a silicon oxide film, are arranged on the driving circuit (driving transistor) 160, which applies an electric field to the light emitting layer 112 of the organic electroluminescence device 110, and the light detecting device 120, these insulating films 122 and 123 and the passivation film 124 in the light detecting device 120 act as a gate insulating film when the positive pole 111 is regarded as a gate electrode and a drop width from a potential of the positive pole 111 is determined by a voltage drop by the thickness of the gate insulating film. The first insulating film 122, the second insulating film 123 and the passivation film 124, which constitute the gate insulating film, are made of, for example, SiO₂ and are formed by a deposition method or a sputtering method or the like.

In addition, the gate electrode 133 is formed on a surface of the first insulating film 122 as the gate insulating film which lies immediately above the select transistor 130. A metal material such as Cr, Al or the like is used as a material of the gate electrode 133. Alternatively, ITO or a stacked structure of a metal thin film and ITO is used for the gate electrode 133 if the gate electrode 133 needs transparency. The gate electrode 133 is formed by a deposition method or a sputtering method or the like.

The second insulating film 123 is formed on a substrate surface on which the gate electrode 133 is formed. The second insulating film 123 is formed over the entire surface of the above-formed stack structure. The second insulating film 123 is made of, for example, SiN or the like and is formed by a deposition method or a sputtering method or the like.

The drain electrode 125D as a light detecting device output electrode, the source electrode 125S as a light detecting device ground electrode, and the source electrode 134S and drain electrode 134D of the select transistor 130 are formed on the second insulating film 123. The drain electrode 125D and the source electrode 125S are connected to the source region 121S and the drain region 121D of the light detecting device 120, respectively. The drain electrode 125D transmits an electrical signal outputted from the light detecting device 120 and the source electrode 125S grounds the light detecting device 120.

On the other hand, the source electrode 134S and the drain electrode 134D are connected to the source region 132S and the drain region 132D of the select transistor 130, respectively. When a predetermined potential is applied to the gate electrode 133 under application of a predetermined potential difference between the source electrode 134S and the drain electrode 134D, an electric field is applied to a channel region 132C and the select transistor 130 functions as a switching device accordingly.

Metal such as Cr or the like is used as a material of the drain electrode 125D, the source electrode 125S, the source electrode 134S and the drain electrode 134D. As shown in FIG. 2A, the drain electrode 125D as the light detecting device output electrode and the source electrode 125S as the light detecting device ground electrode are connected to an end portion of the light detecting device 120 via the first insulating film 122 and the second insulating film 123. Similarly, as shown in FIG. 2C, the source electrode 134S and the drain electrode 134D of the select transistor 130 are connected to an end portion of the select transistor 130 via the first insulating film 122 and the second insulating film 123. Accordingly, prior to forming the drain electrode 125D, the source electrode 125S, the source electrode 134S and the drain electrode 134D, it is necessary to form a through hole for connecting the drain electrode 125D and the source electrode 125S to the light detecting device 120 and a through hole for connecting the source electrode 134S and the drain electrode 134D to the select transistor 130 in the first insulating film 122 and the second insulating film 123. These through holes have a depth until a surface of the light detecting device 120 and a surface of the select transistor 130, that is, a contact surface of the light detecting device 120 with the drain electrode 125D and the source electrode 125S and a contact surface of the select transistor 130 with the source electrode 134S and the drain electrode 134D, are exposed. These through holes are formed immediately above end portions of the light emitting device 120 and the select transistor 130, respectively, by an etching process or the like. A halogen etching gas is used for the etching process. The etching gas is introduced under a state where a surface is coated with a resist pattern having openings formed by a photolithography process, and the surface is patterned to form the through holes of the first insulating film 122 and the second insulating film 123. At this time, a gas that does not chemically react with materials composing the light detecting device 120 and the select transistor 130 is selected as the etching gas. After completing the process of exposing the contact surface of the light detecting device 120 with the drain electrode 125D and the source electrode 125S and the contact surface of the select transistor 130 with the source electrode 134S and the drain electrode 134D, the drain electrode 125D, the source electrode 125S, the source electrode 134S and the drain electrode 134D are formed. The source electrode 134S and the drain electrode 134D are obtained when a metal layer as a sensor electrode is equally formed on a surface of the second insulating film 123, surfaces and both sensor electrode of the through holes, a surface of the light detecting device 120, and the contact surface of the select transistor 130, the metal layer is etched, and then the etched metal layer is divided into the drain electrode 125D, the source electrode 125S, the source electrode 134S and the drain electrode 134D.

After the drain electrode 125D as the light detecting device output electrode, the source electrode 125S as the light detecting device ground electrode, the source electrode 134S and the drain electrode 134D are formed, the passivation film 124 is formed. The passivation film 124 is made of, for example, SiN or the like and is formed by a deposition method, a sputtering method or the like.

The positive pole 111 is formed on the passivation film 124. The positive pole 111 is made of, for example, ITO (Indium Tin Oxide). In addition to the ITO, the positive pole 111 may be made of IZO (Indium Zinc Oxide), ATO (Antimony Tin Oxide), AZO (Aluminum Zinc Oxide), ZnO, SnO, SnO₂, In₂O₃ and the like. As shown in FIG. 2A, the positive pole 111 is formed on a surface of the passivation film 124 immediately above the light detecting device 120. The positive pole 111 is connected to the driving circuit 160 (in more detail, a drain electrode (not denoted by a reference numeral) of the driving circuit 160) through the passivation film 124. Accordingly, prior to forming the positive pole 111, it is necessary to form a through hole in the passivation film 124. This through hole is formed by an etching process or the like. After performing the etching process, a layer of the positive pole 11 is formed. Although the positive pole may be formed by a deposition method, it is preferably formed by a sputtering method.

After the positive pole 111 is formed, the pixel restricting portion 114 is formed using an inorganic insulating material such as silicon nitride, silicon oxide, silicon oxynitride, titanium oxide, aluminum nitride, aluminum oxide and the like, or an organic insulating material such as polyimide, polyethylene and the like. As described above, it is preferable that a material of the pixel restricting portion 114 has high insulating property, high resistance to insulation breakdown, good formability, and good patternability. The pixel restricting portion 114 refers to a member that restricts the light emission region and is defined by an opening formed on an insulating film interposed between the first electrode or the second electrode and the light emitting layer.

In the first embodiment, silicon nitride or aluminum nitride is used as a material composing the silicon nitride film as the pixel restricting portion 114. The pixel restricting portion 114 is formed between the light emitting layer 112, which will be described later, and the positive pole 111, and isolates the light emitting layer 112, which lies outside the light emission region A_{LE}, from the positive pole 111 to restrict a place where the light emitting layer 112 emits light. Accordingly, a region of the light emitting layer 112 that overlaps the pixel restricting portion 114 becomes a non-light emission region while a region of the light emitting layer 112 that does not overlap the pixel restricting portion 114 becomes the light emission region A_{LE}. The pixel restricting portion 114 restricts an area of the light emission region A_{LE} of the light emitting layer 112 to become smaller than an area of the semiconductor island region A_{R} of the light detecting device 120, and is configured to arrange the light emission region A_{LE} inside the semiconductor island region A_{R} of the light detecting device 120.

After the pixel restricting portion 114 is formed, the light emitting layer 112 is formed. The light emitting layer 112 is made of an inorganic light emitting material or a high molecular or low molecular organic light emitting material, which will be described in detail later.

An example of the inorganic light emitting material composing the light emitting layer 112 may include titanium•potassium phosphate, barium•boron oxide, lithium•boron oxide, etc.

Since an inorganic electroluminescence device including the light emitting layer made of the inorganic light emitting material can be manufactured by a screen print, it has little defect in its manufacturing process. In addition, since the inorganic electroluminescence device does not need equipment such as a clean room, it can be manufactured with a high yield. Accordingly, it is possible to provide an exposure device with reduction of production costs.

It is preferable that the high molecular organic light emitting material composing the light emitting layer 112 has fluorescence or phosphorescence property in a visible light wavelength range and good formability, and, for example, may be made of a polymer light emitting material such as polyparaphenylenevinylene (PPV), polyfluorene or the like.

An organic compound having a tree-shaped multi-branch structure, such as a dendrimer, may be used for the high molecular light emitting layer 112. Since this organic compound has a tree-shaped multi-branch high molecular structure or a tree-shaped multi-branch low molecular structure in which a light emission structural unit is surrounded by a plurality of external structural units in a three-dimension, the light emission structural unit is isolated in a three-dimension and the organic compound takes a fine particle shape. On this account, when the light emitting layer 112 has a thin film shape, an aggregate of organic compounds can have high strength and long light emission lifetime since adjacent light emission structural units are prevented from being closed to each other due to the existence of external structural units and the adjacent light emission structural units are uniformly distributed in the thin film.

An example of the low molecular organic light emitting material composing the light emitting layer 112 may include fluorescent whitening agent, for example, benzooxazoles such as Alq₃, Be-benzoquinolynol (BeBq₂), 2,5-bis(5,7-di-t-phentyl-2-benzooxalzolyl)-1,3,4-thiadiazole, 4-4′-bis(5,7-bentyl-2-benzooxazolyl)stilbene, 4-4′-bis[5,7-di-(2-methyl-2-butyl)-2-benzooxazolyl]stilbene, 2,5-bis(5,7-di-t-bentyl-2-benzooxazolyl)thiophene, 2,5-bis[5-α,α-dimethylbenzil]-2-benzooxazolyl)thiophene, 2,5-bis[5,7-di(2-methyl-2-butyl)-2-benzooxazolyl]-3,4-diphenylthiophene, 2,5-bis(5-methyl-2-benzooxazolyl)thiophene, 4,4′-bis(2-benzooxazolyl)biphenyl, 5-methyl-2-[2-[4-(5-methyl-2-benzooxazolyl)phenyl]vinyl]benzooxazolyl, 2-[2-(4-chlorophenyl)vinyl]naphtha[1,2-d]oxazole and the like, benzothiazoles such as 2,2′-(p-phenylenedivinylene)-bisbenzothiazole and the like, benzoimidazoles such as 2-[2-(4-carboxylphenyl)vinyl]benzoimidazole, etc., 8-hydroxyquinolene metal complex such as tris(8-quinolynol)aluminum, tris(8-quinolynol)magnesium, bi(benzo[f]-8-quinolynol)zinc, bis(2-methyl-8-quinolynolate)aluminumoxide, tris(8-quinolynol)indium, tris(5-methyl-8-quinolynol)aluminum, 8-quinolynollithium, tris(5-chloro-8-quinolynol)gallium, bis(5-chloro-8-quinolynol)calcium, poly[zinc-bis(8-hydroxy-5-quinolynol)methane] and the like, a metal chelated oxynoid compound such as dilithium epindridione and the like, a styrylbenzene compound such as 1,4-bis(2-methylstyryl)benzene, 1,4-(3-methylstyryl)benzene, 1,4-bis(4-methylstyryl)benzene, distyrylbenzene, 1,4-bis(2-ethylstyryl)benzene, 1,4-bis(3-ethylstyryl)benzene, 1,4-bis(2-methylstyryl)₂-methylbenzene and the like, distyrylpyradine derivatives such as 2,5-bis(4-methylstyryl)pyridine, 2,5-bis(4-ethylstyryl)pyridine, 2,5-bis(2-91-naphthyl)vinyl]pyridine, 2,5-bis(4-methoxystyryl)pyridine, 2,5-bis[2-(4-biphenyl)vinyl]pyridine, 2,5-bis[2-(1-pyrenyl)vinyl]pyridine and the like, naphthalimide derivatives, pherylene derivatives, oxadiazole derivatives, aldazine derivatives, cyclopentadiene derivatives, styrylamine derivatives, coumarin derivatives, aromatic dimethylidyne derivatives, etc. In addition, anthracene, salicyclic acid salt, pyrene, coronene, etc. are used as the low molecular organic light emitting material. Alternatively, a phosphorescence light emitting material such as fac-tris(2-phenylpyridine)iridium and the like may be used as the low molecular organic light emitting material.

The light emitting layer 112 made of the high molecular material or the low molecular material is obtained by forming a material dissolved into a solvent such as toluene or xylene in the form of a layer using a spin coat method, an inkjet method, a gap coating method, or a wet film forming method represented by a printing method and volatilizing the solvent in the solution. Particularly, the light emitting layer 112 made of the low molecular material is typically obtained by stacking a material using a vacuum deposition method, a deposition polymerization method or a CVD method, but may be formed using any methods depending on properties of light emitting materials.

In addition, for the sake of convenience, although it is illustrated in the first embodiment that the light emitting layer 112 is configured as a single layer, the light emitting layer 112 may be configured as a three-layered structure (not shown) of hole transport layer/electron block layer/the above-described organic light emitting material layer formed in order from a side of the positive pole 111, or a double-layered structure (not shown) of electron transport layer/the organic light emitting material layer formed in order from a side of the negative pole 113, or a seven-layered structure (not shown) of hole injection layer/hole transport layer/electron block layer/the organic light emitting material layer/hole block layer/electron transport layer/electron injection layer formed in order from a side of the positive pole 111. Alternatively, the light emitting layer 112 may be simply configured as a single-layered structure of the above-described organic light emitting material layer. In this manner, in the first embodiment, the light emitting layer 112 may include a multi-layered structure having various functional layers such as the hole transport layer, the electron block layer, the electron transport layer, etc. This is true of other embodiments to be described later.

Of the above-mentioned functional layers, it is preferable that the hole transport layer has high hole mobility, transparency and good formability. An example of a material of the hole transport layer may include organic materials, for example, TPD (triphenyl-diamine), a polypyrine compound such as porphine, tetraphenylporphine copper, phthalocyanine, copper phthalocyanine, titanium phthalocyanine oxide and the like, aromatic tertiary amine such as 1,1-bis{4-(di-P-trylamino)phenyl}cyclohexane, 4,4′,4″-trimethyltriphenylamine, N,N,N′,N′-tetrakis(P-tryl)-P-phenylenediamine, 1-(N,N-di-P-trylamino)naphthalene, 4,4′-bis(dimethylamino)-2-2′-dimethyltriphenylmethane, N,N,N′,N′-tetraphenyl-4,4′-diaminobiphenyl, N,N′-diphenyl-N,N′-di-m-tryl-4,4′-diaminophenyl, N-phenylcarbazole and the like, a stilbene compound such as 4-di-P-trylaminostilbene, 4-(di-P-trylamino)-4′-[4-(di-P-trylamino)styryl]stilbene and the like, triazole derivatives, oxadiazole derivatives, imidazole derivatives, polyarylalkane derivatives, pyrazoline derivatives, pyrazolone derivatives, phenylenediamine derivatives, anilamine derivatives, amino-substitution chalcone derivatives, oxazole derivatives, styrylanthracene derivatives, fluorenone derivatives, hydrazine derivatives, silazane derivatives, polysilane aniline copolymer, polymer oligomer, a styrylamine compound, an aromatic dimethylridine compound, polythiophene derivatives such as poly-3,4 ethylenedioxythiophene (PEDOT), tetradihexylfluorenylbiphenyl (TFB) or poly3-methylthiophene (PMeT), etc. In addition, a high molecular dispersion system where an organic material for low molecule hole transport layer is dispersed into high molecules of polycarbonate or the like may be used as the hole transport layer.

In addition, an inorganic oxide such as MoO₃, V₂O₅, WO₃, TiO₂, SiO, MgO or the like may be used for the hole transport layer. Particularly, when transition metal oxide such as MoO₃ or V₂O₅ is used as the hole transport layer, it is possible to provide an organic electroluminescence device with high efficiency and long lifetime. In addition, these hole transport materials may be as electron block materials.

An example of a material of the electron transport layer of the above-mentioned functional layers may include a polymer material, for example, oxadiazole derivatives such as 1,3-bis(4-tert-butylphenyl-1,3,4-oxadiazolyl)phenylene (OXD-7), anthraquinodimethane derivatives, diphenylquinone derivatives, silole derivatives or the like, bis(2-methyl-8-quinolinolate)-(para-phenylphenolate)aluminum (BAlq), Bathocuproin (BCP), etc. In addition, these materials composing the electron transport layer may be used as the hole block material.

After the light emitting layer 112 is formed, the negative pole 113 is formed. The negative pole 113 is obtained by forming metal such as Al or the like in the form of a layer by a deposition method or the like. An example of a material of the negative pole 113 of the organic electroluminescence device 110 may include metal having a low work function or an alloy thereof, for example, metal such as Ag, Al, In, Mg, Ti or the like, an Mg alloy such as an Mg—Ag alloy, an Mg—In alloy or the like, an Al alloy such as an Al—Li alloy, an Al—Sr alloy, an Al—Ba alloy or the like, etc. Alternatively, the negative pole 113 may employ a metal stack structure including a first electrode layer contacting an organic layer made of metal such as Ba, Ca, Mg, Li, Cs or the like, or nitride or oxide of these metals such as LiF, CaO or the like, and a second electrode layer that is formed on the first electrode layer and is made of metal such as Ag, Al, In or the like.

The exposure device of the first embodiment employs a system of using light that is emitted from the organic electroluminescence device 110 and passes the glass substrate 100. Such a structure of the organic electroluminescence device is called a bottom emission structure.

Since the bottom emission structure draws out light from a side of the glass substrate 100, it is required that the light detecting device 120 should be made of a material having high transparency, for example, polycrystalline silicon (polysilicon). The light detecting device 120 made of polysilicon has a problem in that it generates low photoelectric current, as compared to a light detecting device made of amorphous silicon. This problem may be overcome by, for example, arranging a condenser (not shown) in the vicinity of the organic electroluminescence device 110 and arranging a processing circuit that accumulates charges based on current outputted from the light detecting device 120 in the condenser for a predetermined period of time or conversely, discharges accumulated charges and then performs a voltage conversion. The bottom emission structure has an advantage of simplification of a manufacturing process since an electrode (positive pole) at a side from which light is drawn out can become transparent without difficulty.

As shown in FIG. 1, the exposure device of the first embodiment is such configured that a plurality of organic electroluminescence devices 110 is arranged in a main scan direction (direction of the light emitting device array) and a plurality of light detecting devices 120 is arranged in correspondence to a plurality of light emitting regions. By employing such a configuration, the light detecting devices 120 can measure the emission amount of the organic electroluminescence devices 110 independently. In addition, since the light detecting devices 120 are isolated from the organic electroluminescence devices 110 by thin films (the first insulating film 122, the second insulating film 123 and the passivation film 124), and accordingly, light leakage in a plane direction is extremely low, an effect of optical cross-talk may be mostly ignored. This also makes it possible to measure the light intensity of the plurality of organic electroluminescence devices simultaneously, thereby significantly shortening measurement time.

FIG. 2A shows an interrelation between the light detecting device 120, the drain electrode 125D as the light detecting device output electrode, the source electrode 125S as the light detecting device ground electrode, the light emission region A_{LE}, the semiconductor island region A_{R} as the device region of the light detecting device 120, the ITO (Indium Tin Oxide) 111 as the positive pole of the light emitting layer 112, a contact hole H_{B}, and the train electrode of the driving circuit 160. The light detecting device 120 is connected to the drain electrode 125D and the source electrode 125S. The drain electrode 125D as the light detecting device output electrode is an electrode that transmits an electric signal, which is outputted from the light detecting device 120, to the processing circuit 59 via the select transistor 130 shown in FIG. 2C.

Based on the electric signal outputted from the light detecting device 120, the processing circuit 59 generates light intensity measurement data and a feedback signal is determined by a light intensity correcting part (not shown). A process required for correction of light intensity is performed based on the feedback signal.

In the first embodiment, the light intensity of the organic electroluminescence devices 110 is corrected based on the feedback signal and the source driver 61 (shown in FIG. 9) controls a value of current that drives the organic electroluminescence devices 110. Although the light intensity is controlled based on the output of the light detecting device 120 in the first embodiment, it may be configured to perform a so-called PWM control that controls driving time of the organic electroluminescence devices 110 based on the feedback signal. The PWM control has a merit of control with a full digital circuit configuration.

The source electrode 125S as the light detecting device ground electrode is an electrode that grounds the light detecting device 120. The ITO (Indium Tin Oxide) layer as the positive pole 111 of the organic electroluminescence device 110 as the light emitting device is connected to the drain electrode of the driving circuit (driving transistor) 160 and the organic electroluminescence device 110 is controlled by the driving circuit 160 through the drain electrode.

As shown in FIG. 1, the exposure device of the first embodiment is such configured that the light detecting devices 120, which are made of polycrystalline silicon (polysilicon) and are formed in an island shape, are arranged in a row in the main scan direction, and light detecting devices 120 having the semiconductor island region A_{R} larger than the light emission region A_{LE} are arranged below the light emitting layer 112 having the light emission region A_{LE} restricted by the silicon nitride film as the pixel restricting portion 114 in the organic electroluminescence device 110. By making the semiconductor island region A_{R} (a portion having an island shape of polysilicon) of the light detecting device 120 larger than the light emission region A_{LE}, a structure having steps of the source electrode 125S and the drain electrode 125D is excluded from a portion where the light emission region A_{LE} is formed. Accordingly, at least the light emission region A_{LE} is formed on a flat portion of the light detecting device 120. Thus, even if the light emitting layer 112 is particularly formed by the above-mentioned wet method, since local variation of the thickness of the light emitting layer 112 can be suppressed, bias of current flowing through the light emitting layer 112 can be suppressed. Accordingly, it is possible to manufacture an exposure device with uniform light emission distribution and increase of lifetime.

In addition, since the semiconductor island region A_{R} of the island-shaped light detecting device 120 loaded into the exposure device of the first embodiment is larger than the light emission region A_{LE}, light outputted from the light emitting layer 112 can be efficiently converted into an electric signal used to correct the light intensity.

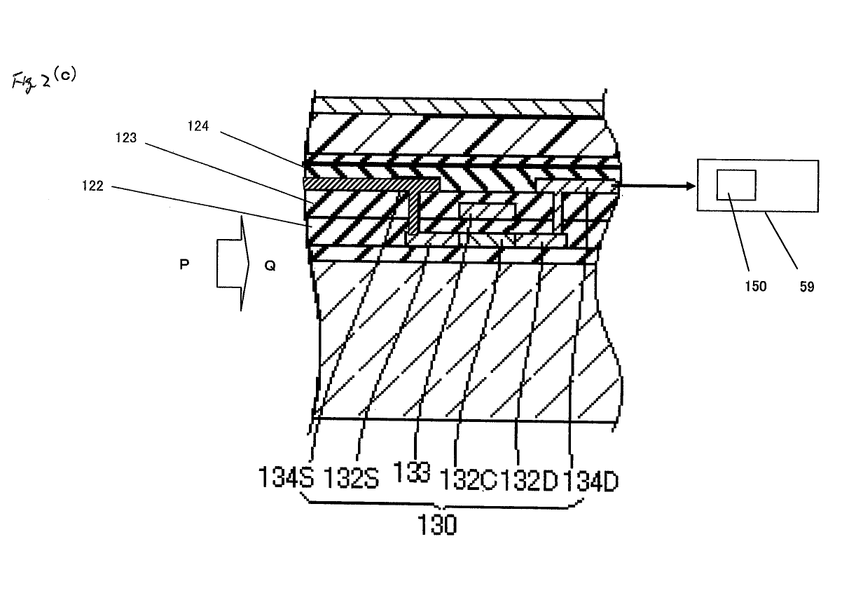

FIG. 3 is a circuit diagram of the light intensity detecting circuit C and the processing circuit 59 loaded into the exposure device according to the first embodiment of the invention.

Hereinafter, the light intensity detecting circuit C and the processing circuit 59 that processes output from light intensity detecting circuit C, which are used in the exposure device of this embodiment, will be described in detail with reference to FIG. 3. In the following description, the light intensity detecting circuit C and the processing circuit 59 that processes output from light intensity detecting circuit C are collectively called a light intensity measuring part 241.

As shown in FIG. 3, the light intensity measuring part 241 is comprised of the processing circuit 58 as a driving IC having a charge amplifier constituted by an operational amplifier 151 and the like and the light intensity detecting circuit C that is integrated on the glass substrate 100 in such a manner that this circuit C is connected to an input terminal of the processing circuit 59. The light intensity detecting circuit C is comprised of the select transistor 130 and the capacitive element (condenser) 140 that is connected in parallel to the light detecting device 120 and is discharged by output current (photoelectric current) of the light detecting device 120.

Hereinafter, FIG. 3 will be described in conjunction with FIGS. 1, 2A, and 2B.

As can be seen from FIGS. 1 and 2B, the capacitive element 140 is composed of conductive films formed by the same process as the source electrode 125S and the drain electrode 125S of the light detecting device 120 to which the conductive films are connected respectively, and the first insulating film 122 interposed between the conductive films.

With this configuration, the light detecting device 120 detects the light intensity by performing photoelectric transformation for the light from the organic electroluminescence device 110 in the channel region 121i made of polycrystalline silicon and then drawing out current flowing through the drain region 121D, as photoelectric current, from the source region 121S.

However, when charges accumulated in the capacitive element 140 are measured, if the organic electroluminescence device 110 is turned on, a predetermined voltage is applied to the positive pole 111 of the organic electroluminescence device 110, as described above. On this account, the positive pole 111 functions as a gate electrode in the light detecting device 120.

An electric field is applied to the polycrystalline layer as the channel region 121i of the light detecting device 120 by a potential of the gate electrode (positive pole 111), and thus, drain current I_{D} flows. Since the drain current ID is added to the photoelectric current, photoelectric current outputted, as sensor output from the drain electrode 125D, to the light intensity circuit C is the addition of actual photoelectric current and the drain current I_{D}. Accordingly, there arises a problem of deterioration of light intensity detection precision.

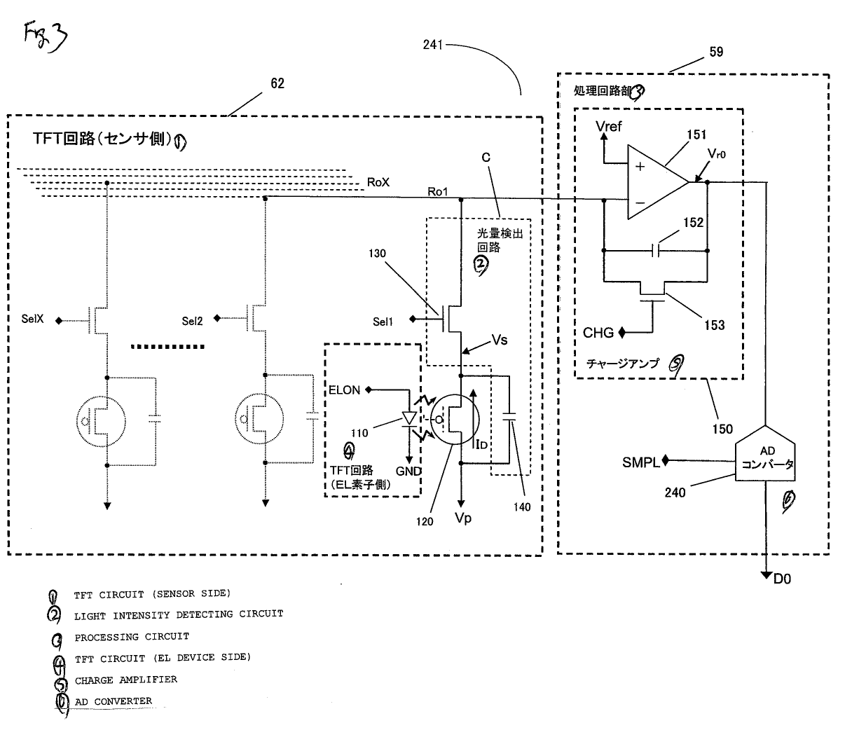

FIG. 4 is an explanatory view illustrating a relationship between a gate voltage Vg and the drain current I_{D} of the light detecting device 120 according to the first embodiment of the invention.

In FIG. 4, a result of measurement of a relationship between the gate voltage Vg and the drain current I_{D} is indicated by a solid line. Since it is preferable that variation of the drain current I_{D} due to variation of the gate voltage Vg is small in order to secure high light intensity detection precision, it is preferable to use a region where the drain current I_{D} of the TFT is 0, that is, a region where the TFT is turned off (OFF region), as apparent from FIG. 4.

In the relationship between the gate voltage Vg and the drain current I_{D}, since there exists a region into through the current I_{D} flows in a region of Vg>0, and thus, there occurs variation of the drain current ID due to variation of the gate voltage Vg, the TFT can be used in the OFF region by shifting a gate potential in a minus direction, as indicated by a dotted line in FIG. 4, with producing almost no dark current. In the invention, since it is important to detect output of the light detecting device 120 with high precision, it is important to detect light in the OFF region having the TFT constituting the light detecting device 120.

Since the light detecting device 120 has the configuration that the amount of the drain current I_{D} and the photoelectric current is determined by an electric field applied to the polycrystalline silicon layer as the channel region 121i of the TFT constituting the light detecting device 120, for example if a portion of the channel region 121i of the TFT is not covered with the positive pole 111, it is difficult to control an electric field at the portion not covered with the positive pole 111, and moreover, there arises a problem of deterioration of light intensity detection precision due to an indefinite electric field such as surface electric field or an external electric field, that is, a disturbance. Accordingly, a configuration that the overall polycrystalline silicon layer as the channel region 121i of the TFT is completely covered with the positive pole 111 of the organic electroluminescence device 110 is more effective in controlling a channel using a gate electric field.

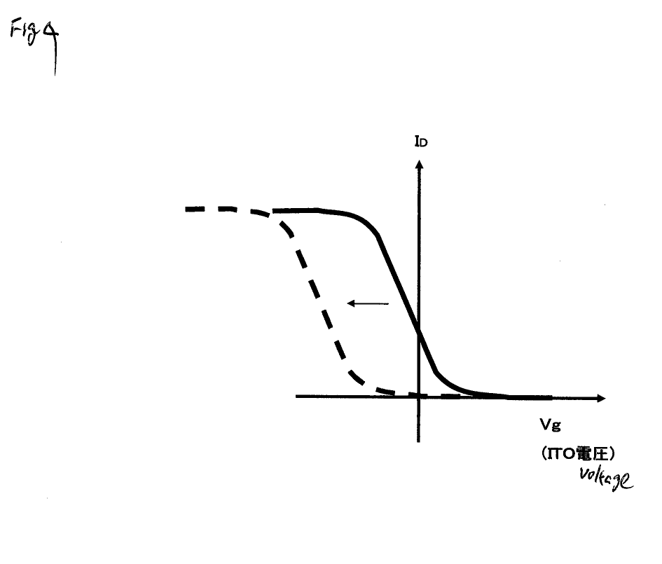

FIG. 5 is a timing chart showing a timing of light intensity detection according to the first embodiment of the invention.

Hereinafter, FIG. 5 will be described in conjunction with FIG. 3.

(A) in FIG. 5 shows an ON/OFF state of a switching transistor 153 in the charge amplifier 150. The switching transistor 153 has a function of resetting charged accumulated in a capacitive element 152, and a charge period (more precisely, a discharge period which will be described later) of the capacitive element 140 in the light intensity detecting circuit C is defined by the ON/OFF operation of the switching transistor 153.

(B) in FIG. 5 shows an operation timing of the select transistor 130. The select transistor 130 is controlled to be turned ON/OFF based a signal SELx. When the signal SELx goes to a high level, the select transistor 130 is turned ON.

(C) in FIG. 5 shows a lightening timing of the organic electroluminescence device 110. As can be seen from (C) in FIG. 5, the organic electroluminescence device 110 emits light when a signal ELON goes to a high level.

(D) in FIG. 5 shows potential variation between both ends of the capacitive element 140 (that is, between the source electrode 125S and the drain electrode 125D shown in FIG. 2A) in the light intensity detecting circuit C.

(E) in FIG. 5 shows an output voltage of the operational amplifier 151.

(F) shows a timing at which an output Vᵣ₀ of the operational amplifier 151 is sample-held.

(G) in FIG. 5 shows a timing at which a sample-held analog signal is AD-converted (that is, converted into a digital signal) by an AD converter 240 (see FIG. 3) and digitalized data are outputted.

The intensity of light outputted from the light detecting device 120 can be detected with high precision by drawing out current charged into the capacitive element 140 by a lightening time corresponding to the desired number of times of the organic electroluminescence device 110 by switching of the select transistor 130, as shown in the timing chart of (A) to (E) in FIG. 5.

Hereinafter, the operation timing in the light intensity detecting operation will be described in detail.

First, the select transistor 130 is turned ON based on the signal SELx and an initial voltage V_{ref} is charged into the capacitive element 140 by the charge amplifier 150 (S1: reset step).

Next, when the select transistor 130 is turned OFF based on the signal SELx and the signal ELON is controlled to lighten the organic electroluminescence device 110, the channel region 121i (see FIG. 2A) of the light detecting device 120 that receives light from the organic electroluminescence device 110 exhibits conductivity proportional to the light intensity. At this time, charges accumulated in the capacitive element 140 in the reset step S1 decrease by photoelectric current flowing into the light detecting device 120. That is, the capacitive element 140 is discharged depending on the light intensity of the organic electroluminescence device 110 (S2: lightening step).

Next, the switching transistor 153 constituting the charge amplifier 150 is turned OFF based on a signal CHG so that the charge amplifier 150 can measure charges accumulated in the capacitive element 140 (S3: measurement initiation step).

Next, when the select transistor 130 is turned ON based on the signal SELx, the charges accumulated in the capacitive element 140 provided in the light intensity detecting circuit C are transferred to the capacitive element 152 constituting the charge amplifier 150. As a result, the output voltage Vᵣ₀ of the operational amplifier 151 constituting the charge amplifier 150 increases. Although the photoelectric current of the light detecting device 120 also increases during this time, since this current is minute for a short time, an effect of this current may be mostly ignored (S4: charge transfer step).

Finally, when the select transistor 130 is turned OFF based on the signal SELx, Vᵣ₀ is determined. At this time, the output voltage Vᵣ₀ of the operational amplifier 151 is inputted to the AD converter 240, the light intensity detecting operation is ended, and an output D0 of the AD converter 240 is determined (S5: read step).

The obtained output D0 (digitalized as described above) of the light intensity measuring part 241 is processed by a known computer system including, for example, an arithmetic part such as a microcomputer, a nonvolatile memory such as a ROM storing a process program, a rewritable memory such as a RAM to provide a work area used for the arithmetic, a bus interconnect these components, etc. (hereinafter, the computer system is referred to as a light intensity correcting part) to determine the light intensity or light emission time as driving conditions of the organic electroluminescence device 110.

When the light intensity of the driving conditions of the organic electroluminescence device 110 is corrected, the light intensity correcting part calculates new driving current (or a driving voltage, or a driving time) for the organic electroluminescence devices 110 constituting the exposure device and sets driving parameters based on a result of the calculation in a driving condition setting part (not shown). Accordingly, when the driving circuit 160 (see FIG. 2A) is turned ON, the driving conditions of the organic electroluminescence device 110 are controlled.

Based on the obtained output voltage of the light intensity detecting circuit C, the charge amplifier 150 as a light intensity arithmetic circuit calculates a correction voltage, and a voltage applied to the positive pole 111 and the negative pole 113 of the light emitting device is controlled through the driving circuit 160. When the voltage is applied to the light emitting layer 112 formed between these poles 111 and 113, unbalance of the light intensity and variation of light intensity with time are compensated for to maintain uniform exposure.

In addition, although it is configured in the first embodiment that the organic electroluminescence devices 110 overlap the light detecting devices 120, they may not overlap with each other. This structure corresponds to a case where a layer on which the light detecting devices 120 are formed is different from a layer on which the light emitting devices (the organic electroluminescence devices 110) are formed, and the light detecting devices 120 are sufficiently isolated from the organic electroluminescence devices 110 and a lower layer of the light detecting devices 120 is flat when viewed from the top.

In addition, when one semiconductor region is divided into an insulating region and an active region by doping or the like and a plurality of light detecting devices 120 is formed in the active region, since the semiconductor region constituting the light detecting devices 120 does not have an island shape, it is possible to partially overlap the light detecting devices 120 with the organic electroluminescence devices 110 when viewed from the top.

### Second Embodiment

Next, an image forming apparatus employing the exposure device of the first embodiment will be described as a second embodiment of the invention.

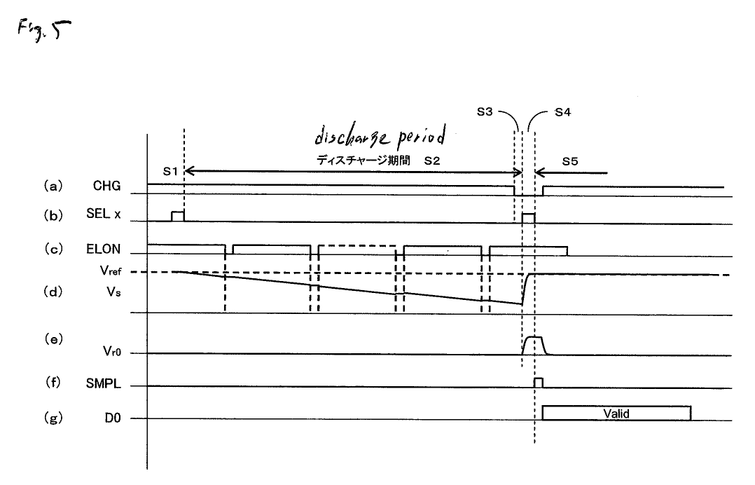

FIG. 6 is a view showing a configuration of an image forming apparatus according to a second embodiment of the invention.

FIG. 6 shows an image forming apparatus 1 employing exposure devices 13Y to 13K formed for yellow, magenta, cyan and black colors.

As shown in FIG. 6, the image forming apparatus 1 is such configured that a yellow developing station 2Y, a magenta developing station 2M, a cyan developing station 2C and a black developing station 2K are vertically arranged in a step shape, a paper feeding tray 4 that accommodates recording papers 3 is arranged above theses stations, and a recording carrying path 5 along which the recording papers 3 fed from the paper feeding tray 4 are carried is formed at places corresponding to the developing stations 2Y to 2K.

The developing stations 2Y to 2K forms yellow, magenta, cyan and black toner images, respectively, in order from an upstream side of the recording carrying path 5. The yellow developing station 2Y includes a photoconductor 8Y, the magenta developing station 2M includes a photoconductor 8M, the cyan developing station 2C includes a photoconductor 8C, and the black developing station 2K includes a photoconductor 8K. In addition, each of the developing stations 2Y to 2K includes members, such as a developing sleeve, a charger and so on, which realize a series of developing processes in an electrophotograpy system.

In addition, the exposure devices 13Y, 13M, 13C and 13K that expose surfaces of the photoconductors 8Y to 8K to light to form electrostatic latent images are arranged below the developing stations 2Y to 2K, respectively.

Since the developing stations 2Y to 2K have the same configuration irrespective of developing color although they are filled with different color developers, the developing stations, the photoconductors and the exposure device will be described without specifying a particular color, for example, as a developing station 12, a photoconductor 8 and a exposure device 13, for the sake of avoiding complexity of description except for a case where they need to be particularly specified.

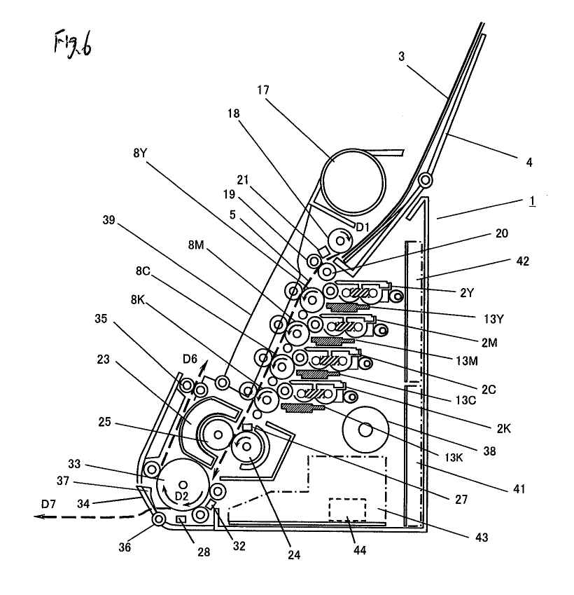

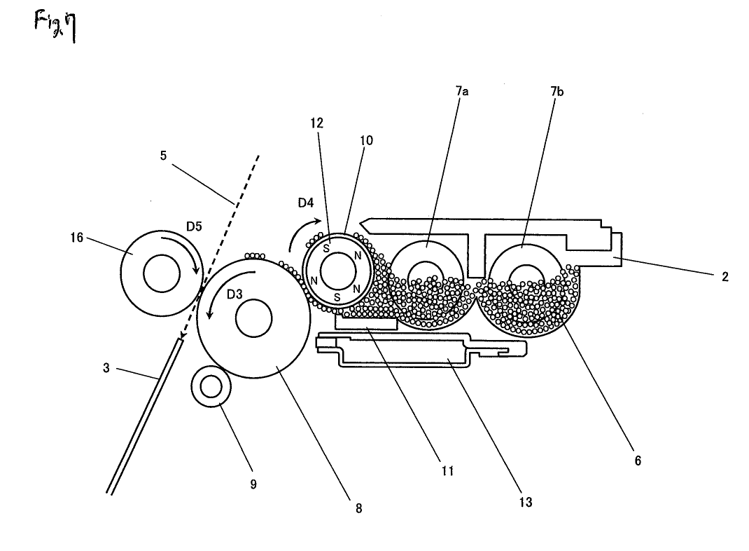

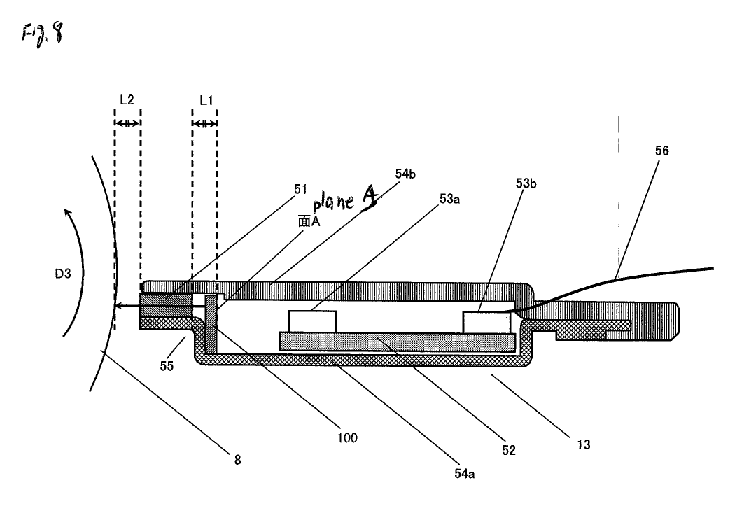

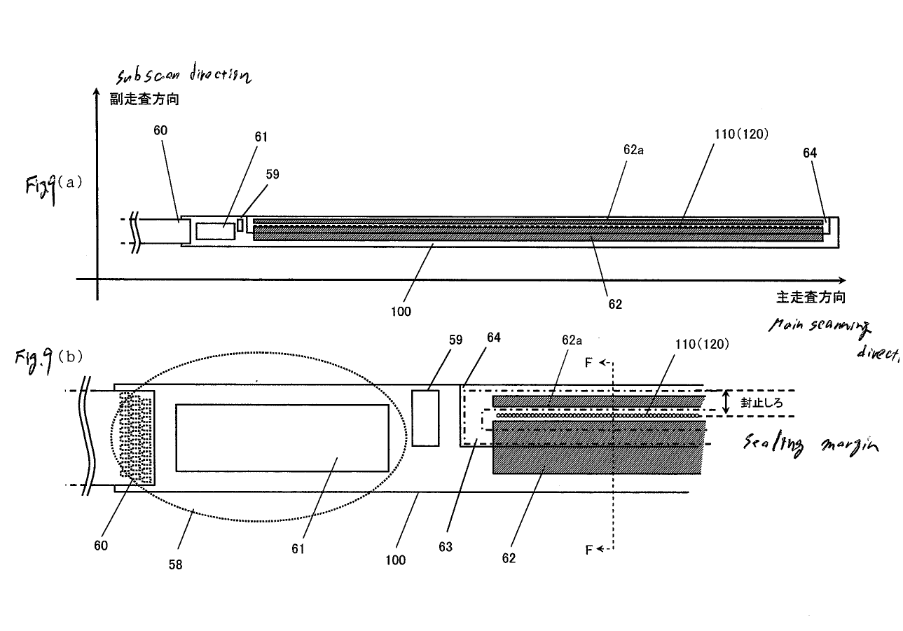

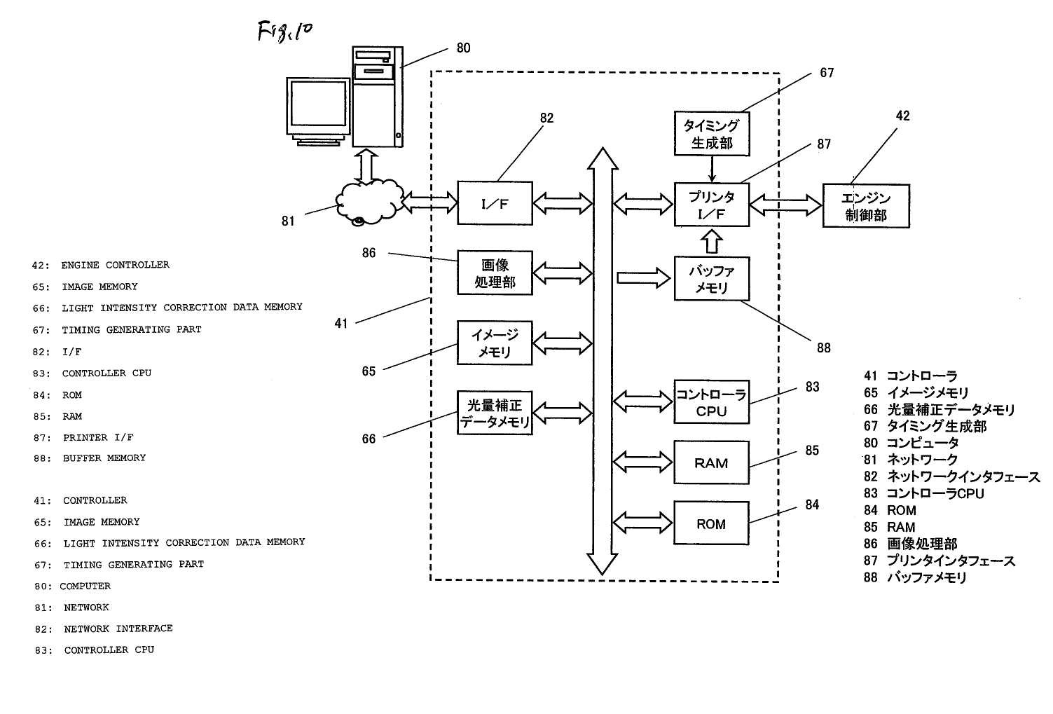

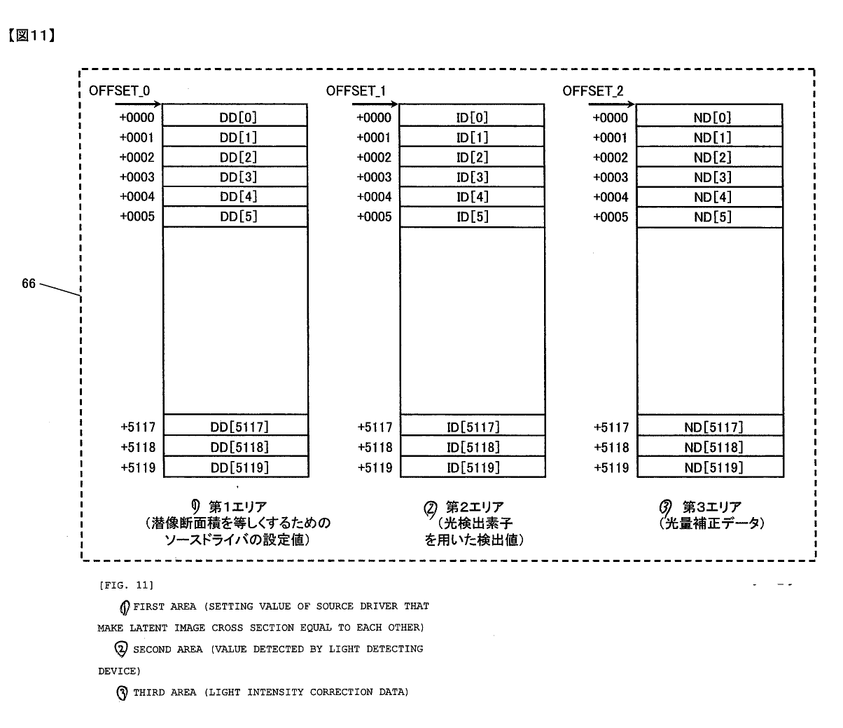

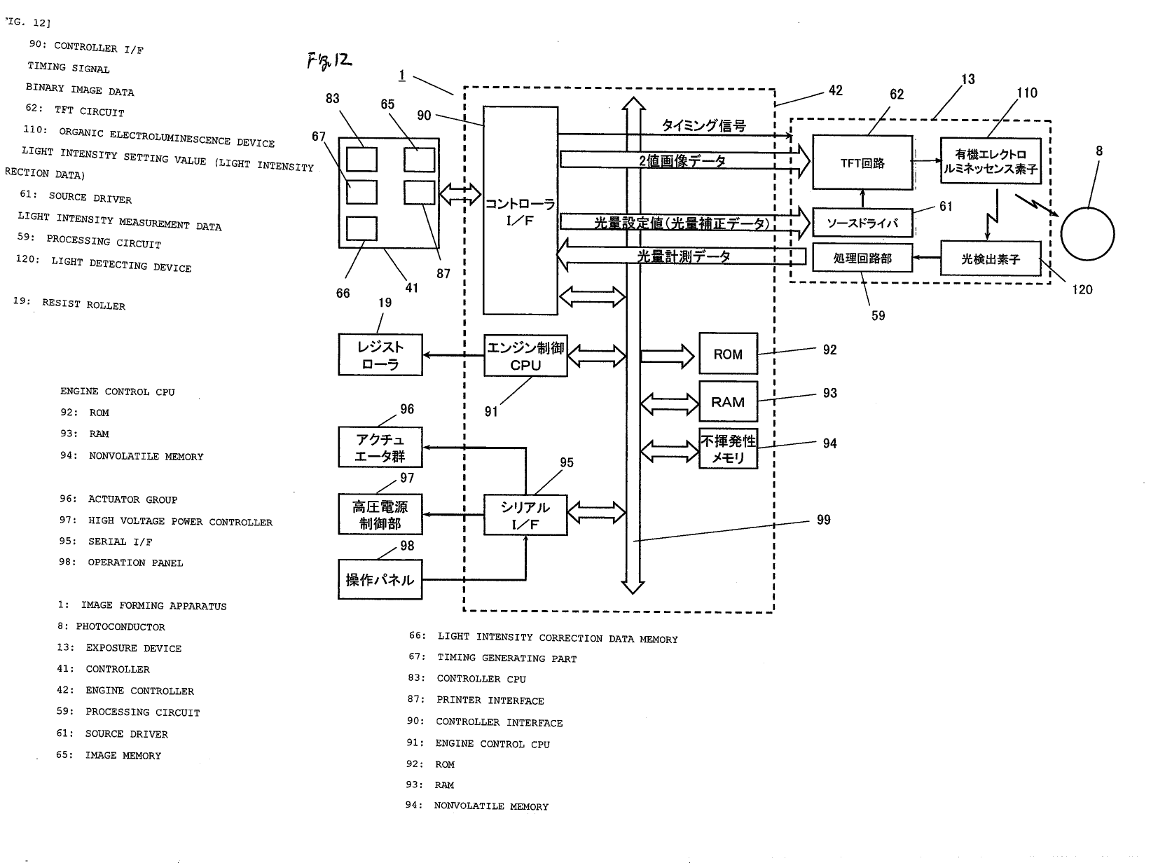

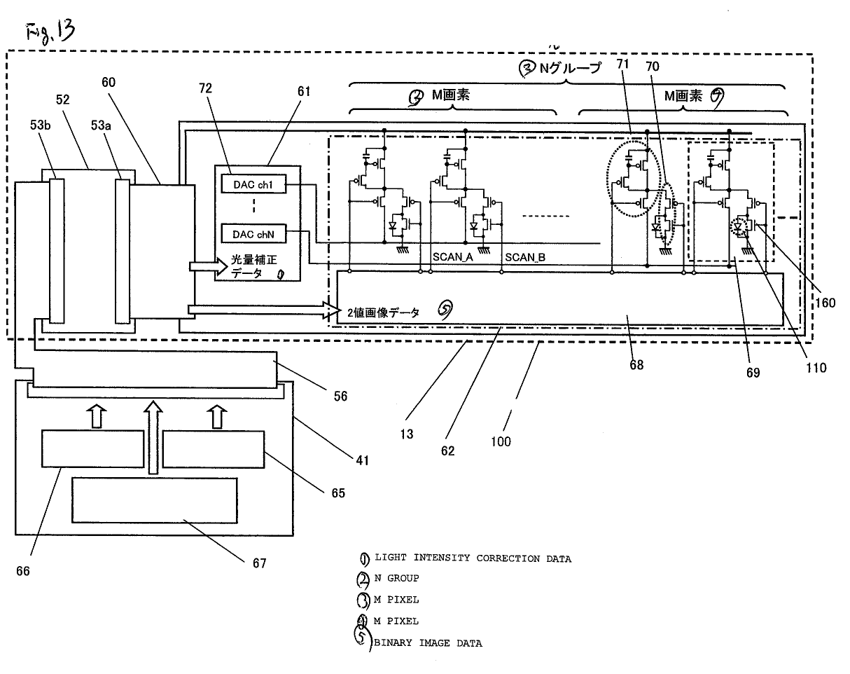

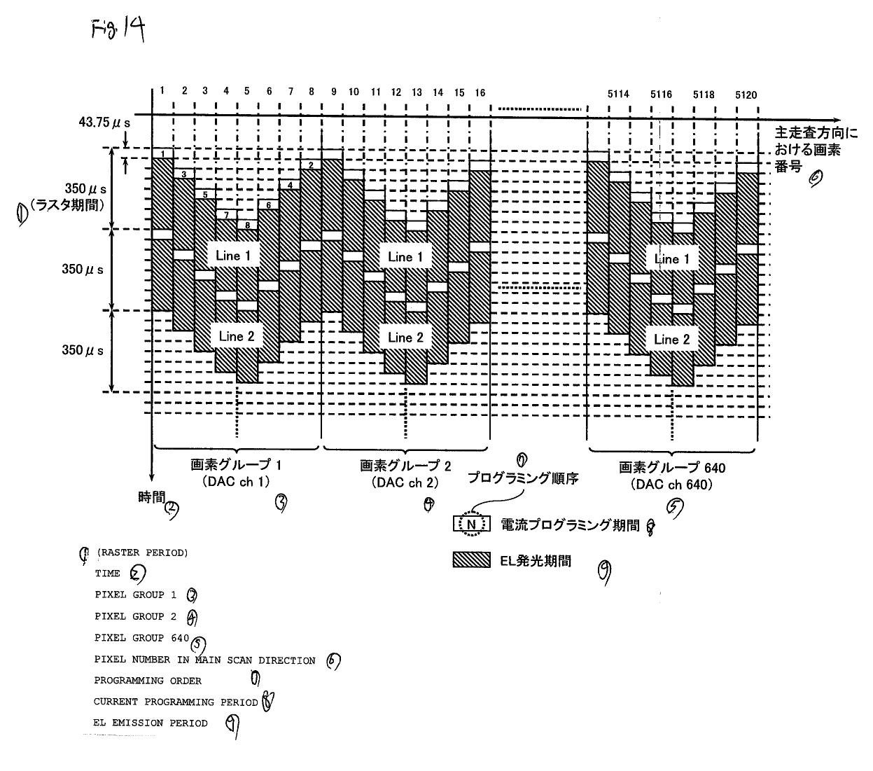

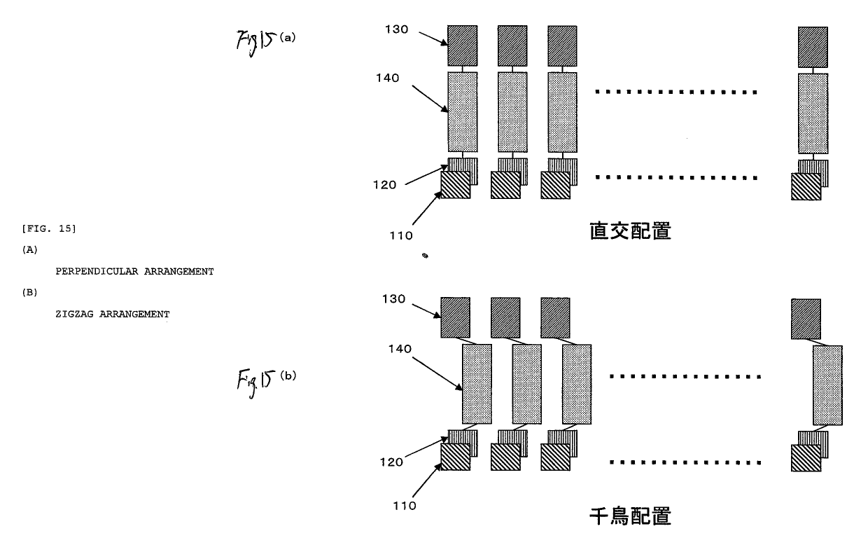

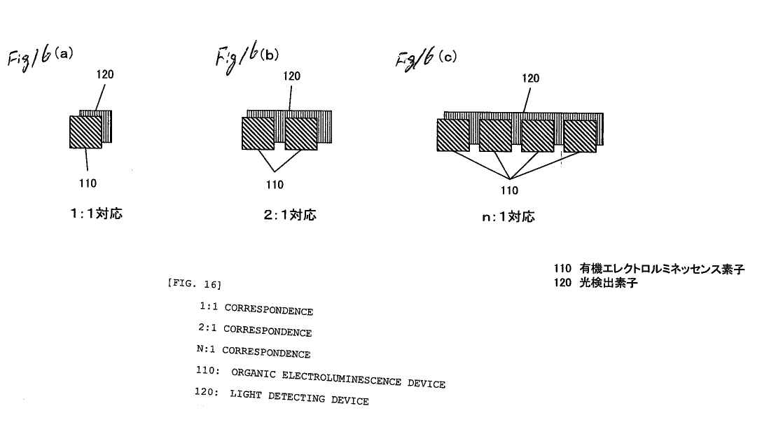

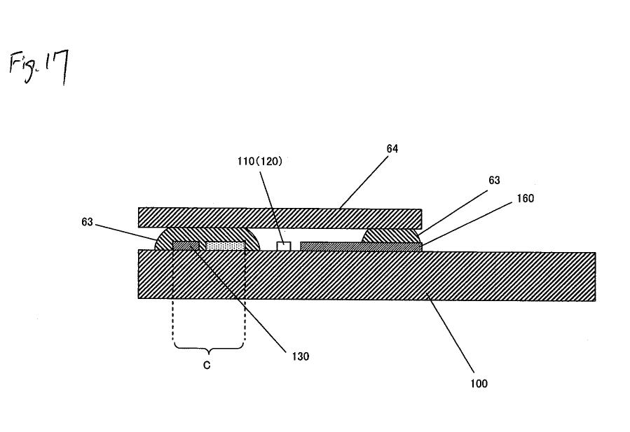

FIG. 7 is a view showing a configuration in the neighborhood of the developing station 2 in the image forming apparatus 1 according to the second embodiment of the invention.

As shown in FIG. 7, the developing station 2 is filled with a developer 6 which is a mixture of carrier and toner. Reference numerals 7a and 7b denote agitating paddles that agitate the developer 6. When the agitating paddles 7a and 7b are rotated, the toner in the developer 6 is charged to a potential by friction with the carrier, and the toner and the carrier are sufficiently agitated with while circulating inside the developing station 2. The photoconductor 8 is rotated by a driving source (not shown) in a direction D3. A reference numeral 9 denotes a charger that charges a surface of the photoconductor 8 to a potential. A reference numeral denotes a developing sleeve, and a reference numeral 11 denotes a thinning blade. The developing sleeve 10 has a magnet roll 12 having a plurality of magnet poles formed therein. A layer thickness of the developer 6 supplied to a surface of the developing sleeve 10 is restricted by the thinning blade 11, the developing sleeve 10 is rotated by the driving source (not shown) in a direction D4, the developer 6 is supplied to the surface of the developing sleeve 10 by the rotation and action of the magnetic poles of the magnet roll 12, and then the electrostatic latent image formed on the photoconductor 8 by the exposure device 13, which will be described later, is developed while some of the developer 6 that is not transferred to the photoconductor 8 is withdrawn inside the developing station 2.

A reference numeral denotes an exposure device. The exposure device 13 has a light emitting device array that is comprised of organic electroluminescence devices as exposure light sources, which are arranged in the form of a row with resolution of 600 dpi (dot/inch), and forms an electrostatic latent image of the maximum of A4 size for the photoconductor 8 charged to a potential by the charger 9 by selectively turning ON/OFF the organic electroluminescence devices according to image data. When a potential (developing bias) is applied to the developing sleeve 10, a potential gradient occurs between the electrostatic latent image and the developing sleeve 10. Then, a coulomb force is exerted on the toner in the developer 6 that is supplied to the surface of the developing sleeve 10 and is charged to the potential, and thus, only the toner in the developer 6 is adhered to the photoconductor 8, thereby developing the electrostatic latent image.

As will be described in detail later, the exposure device 12 is provided with the light detecting devices, 120 which have been described in the first embodiment, as the light intensity measuring means that measures the light intensity of the organic electroluminescence devices.

A reference numeral 16 denotes a transfer roller. The transfer roller 16 opposes the photoconductor 8 with the recording paper carrying path 5 interposed therebetween, and is rotated by a driving source (not shown) in a direction D5. A transfer bias is applied to the transfer roller 16 and a toner image formed on the photoconductor 8 is carried by the recording paper carrying path 5 and is transferred to the recording paper 3.

Hereinafter, returning to FIG. 6, the image forming apparatus will be continuously described.

A reference numeral 17 denotes a toner bottle in which yellow, magenta, cyan and black toners are stored. The toners are supplied from the toner bottle 17 to the developing stations 2Y to 2K through toner carrying pipes (not shown).

A reference numeral 16 denotes a feeding roller that sends the recording paper 3, which is loaded in the feeding tray 4, to the recording paper carrying path 5 while being rotated in a direction D1 by controlling an electromagnetic clutch (not shown).

A pair of resist roller 19 and pinch roller 20 is provided as a nip carrying means at an inlet side on the recording paper carrying path 5 located between the feeding roller 18 and a transfer portion of the uppermost yellow developing station 2Y. The pair of resist roller 19 and pinch roller 20 pauses the recording paper 3 carried by the feeding roller 18 and then carries the recording paper 3 in a direction of the yellow developing station 2Y at a predetermined timing. This pause arranges a leading end of the recording paper 3 to be in parallel to an axial direction of the pair of resist roller 19 and pinch roller 20, thereby preventing the recording paper 3 from moving obliquely.

A reference numeral 21 denotes a recording paper passage detecting sensor. The recording paper passage detecting sensor 21 is composed of a reflection type sensor (photoreflector) and detects leading and trailing ends of the recording paper 3 depending on the presence or absence of reflected light.

When power transmission is controlled by the electromagnetic clutch (not shown) and the resist roller 19 begins to rotate, while the recording paper 3 is carried in a direction of the yellow developing station 2Y along the recording paper carrying path 5, a writing timing of the electrostatic latent image by the exposure devices 13Y to 13K arranged in the vicinity of the developing stations 2Y to 2K, ON/OFF of the developing bias, ON/OFF of the transfer bias, etc. are independently controlled with a rotation initiation timing of the resist roller 19 as a starting point.

Hereinafter, the image forming apparatus will be continuously described with reference to FIG. 7.

Since a distance between the exposure device 13 shown in FIG. 7 and a developing region (near a portion where a gap between the photoconductor 8 and the developing sleeve 10 is smallest) may be randomly set, for example, time taken for the latent image formed on the photoconductor 8 to arrive at the developing region after the exposure device 13 starts an exposure operation may be also randomly set.

In the second embodiment, it is configured that, when a plurality of recording papers is successively printed, which will be described later, the light intensity of the organic electroluminescence devices comprising the exposure device 13 is set and lightened and the developing bias is OFF for a position of the latent image formed on the photoconductor 8 between a recording paper and another recording paper, which are carried on the recording paper carrying path 5, with the rotation initiation timing of the resist roller 19 as the starting point.

Hereinafter, returning to FIG. 6, the image forming apparatus will be continuously described.

A fixer 23 is provided as a nip carrying means at an outlet side on the recording paper carrying path 5 located below the lowermost black developing station 2K. The fixer 23 is comprised of a heating roller 24 and a pressurizing roller 25.

A reference numeral 27 denotes a temperature sensor that detects temperature of the heating roller 24. The temperature sensor 27 is made of a ceramic semiconductor that has metal oxide as a main component and is obtained by firing the metal oxide at a high temperature. The temperature sensor 27 can measure the temperature of an object contacting the sensor 27 based on temperature-dependency of load resistance. An output of the temperature sensor 27 is inputted to an engine controller 42 which will be described later. The engine controller 42 controls power supplied to a heat source (not shown) built in the heating roller 24 based on the output of the temperature sensor 27 and controls a surface temperature of the heating roller 24 to be about 170° C.

When the recording paper 3 having the toner image formed thereon passes through a nip portion formed by the heating roller whose surface temperature is controlled and the pressurizing roller 25, the toner image on the recording paper 3 is heated and pressurized by the heating roller 24 and the pressurizing roller 25 so that the toner image is fixed on the recording paper 3.

A reference numeral 28 denotes a recording paper trailing end detecting sensor that monitors discharge of the recording paper. A reference numeral 32 denotes a toner image detecting sensor. The toner image detecting sensor 32 is a reflection type sensor unit that employs a plurality of light emitting devices having different emission spectrums (visible light) and a single light receiving device. The toner image detecting sensor 32 detects image concentration using a difference between absorption spectrums depending on image color at a surface of the recording paper 3 and an image forming portion. In addition, since the toner image detecting sensor 32 can detect an image forming position as well as the image concentration, the image forming apparatus 1 of the second embodiment includes two toner image detecting sensors 32 arranged in a width direction and controls an image forming timing based on a detection position of an image position deviation detection pattern formed on the recording paper 3.

A reference numeral 33 denotes a recording paper carrying drum. The recording paper carrying drum 33 is a metal roller having a surface coated with 200 μm or so thick rubber. After the fixation, the recording paper 3 is carried in a direction D2 along the recording paper carrying drum 33. At this time, the recording paper 3 is crookedly carried in the opposite to an image forming plane while being cooling by the recording paper carrying drum 33. Accordingly, curl which may occur when an image is formed on the entire surface of the recording paper 3 at high concentration can be significantly reduced. Thereafter, the recording paper 3 is carried in a direction D6 by an ejecting roller 35 and then is discharged to an exit tray 39.

A reference numeral 34 denotes a facedown exiting part. The facedown exiting part 34 can be rotated around a supporting member 36. When the facedown exiting part 34 is in an opened state, the recording paper 3 is exited in a direction D7. When the facedown exiting part 34 is a closed state, a rib 37 is formed at a rear side of the facedown exiting part 34 along a carrying path so that the recording paper 3 is guided by the rib 37 and the recording paper carrying drum 33.

A reference numeral 38 denotes a driving source that employs a stepping motor in the second embodiment. The driving source 38 drives peripherals of the developing stations 2Y to 2K, including the feeding roller 18, the resist roller 19, the pinch roller 20, the photoconductors 8Y to 8K, and the transfer roller 16 (see FIG. 7), the fixer 23, the recording paper carrying drum 33, and the ejecting roller 35.

A reference numeral 41 denotes a controller that receives image data from a computer (not shown) or the like via an external network and develops and generates printable image data. As will be described in detail later, a controller CPU (not shown) quipped in the controller 41 is a light intensity correcting means that receives light intensity measurement data of the organic electroluminescence devices as the light emitting devices from the exposure devices 13Y to 13K and generates light intensity correction data, and simultaneously a light intensity setting means that sets light intensity of the organic electroluminescence devices based on the light intensity correction data.

A reference numeral 42 denotes an engine controller. The engine controller 42 controls hardware and mechanisms of the image forming apparatus 1. Specifically, the engine controller 42 performs an overall control for the image forming apparatus 1, including forming a color image on the recording paper 3 based on the image data and light intensity correction data transmitted from the controller 41, controlling the temperature of the heating roller 24 of the fixer 23, etc.

A reference numeral 43 denotes a power supply. The power supply 43 supplies power to the exposure devices 13Y to 13K, the driving source 38, the controller 41, the engine controller 42, the heating roller 24 of the fixer 23, etc. In addition, the power supply 43 includes a high voltage power source that generates a charge potential to charge the surface of the photoconductor 8, a developing bias to be applied to the developing sleeve (see FIG. 7), a transfer bias to be applied to the transfer roller 16 and so on. The engine controller 42 adjusts an output voltage value or an output current value as well as ON/OFF of high voltage by controlling the power supply 43.

In addition, the power supply 43 includes a power monitor 44 that monitors at least a power voltage supplied to the engine controller 42 and an output voltage of the power supply 43. The engine controller 42 detects a monitor signal to check decrease of power voltage which may occur when a power switch is switched off or due to electrical outage, and abnormal output of the high voltage source.

Hereinafter, an operation of the above-configured image forming apparatus 1 will be described with reference to FIGS. 6 and 7.

In the following description, while the configuration and overall operation of the image will be mainly described with reference to FIG. 6, with distinguished colors like the developing stations 2Y to 2K, the photoconductors 8Y to 8K and the exposure devices 13Y to 13K, the exposing and developing related to monochrome will be mainly described with reference to FIG. 7, without distinguishing between colors like the developing station 2, the photoconductor 8 and the exposure device 13 for the sake of avoiding complexity of description.

### <Initialization Operation>

First, an initialization operation when the image forming apparatus 1 is powered on will be described.

When the image forming apparatus 1 is powered on, an engine control CPU (not shown) equipped in the engine controller 42 performs an error check for electrical resources constituting the image forming apparatus 1, for example, writable/readable registers, a memory, etc. Upon completing the error check, the engine control CPU (not shown) begins to rotate the driving source 38. As described above, the driving source 38 drives peripherals of the developing stations 2Y to 2K, including the feeding roller 18, the resist roller 19, the pinch roller 20, the photoconductors 8Y to 8K, and the transfer roller 16, the fixer 23, the recording paper carrying drum 33, and the ejecting roller 35. Immediately after the image forming apparatus 1 is powered on, the feeding roller 18 and the resist roller 19 related to carrying of the recording paper 3 are controlled so as not to carry the recording paper by setting the electromagnetic clutch (not shown) that transmits a driving force to these rollers 18 and 19 to be OFF.

Hereinafter, the image forming apparatus 1 will be continuously described with reference to FIG. 7.

With the rotation of the driving source 38 (see FIG. 6), the agitating paddles 7a and 7b and the developing sleeve 10 of the developing station 2 begins to rotate, and accordingly, the developer 6 composed of the toner and carrier filled in the developing station 2 is circulated inside the developing station 2, while the toner is charged with negative charges by friction between the toner and the carrier.

After a predetermined period of time elapses from the point of time when the driving source 38 (see FIG. 6) begins to rotate, the engine control CPU (not shown) controls the power supply 43 (see FIG. 6) to set the charger 9 to be ON. The charger 9 charges the surface of the photoconductor 8 to a potential of, for example, −700 V. After a charging region of the photoconductor 8 that is rotating in the direction D3 reaches the developing region, that is, a position at which the photoconductor 8 is closest to the developing sleeve 10, the engine control CPU (not shown) controls the power supply 43 (see FIG. 6) to apply a developing bias of, for example, −400 V to the developing sleeve 10. At this time, since a surface potential of the photoconductor 8 is −700 V and the developing bias applied to the developing sleeve 10 is −400 V, an electric force line directs from the developing sleeve 10 to the photoconductor 8, and a coulomb force exerting on the toner having negative charges directs from the photoconductor 8 to the developing sleeve 10. Accordingly, the toner will not be adhered to the photoconductor 8.

As described above, the power supply (see FIG. 6) has the function of monitoring the abnormal output (for example, leak) of the high voltage source, and the engine control CPU (not shown) can check abnormality which may occur when a high voltage is applied to the charger 9 or the developing sleeve 10.

In the last step of the series of initialization operation, the engine control CPU (not shown) corrects light intensity of the exposure device 13. The engine control CPU (not shown), which is equipped in the engine controller 42 (see FIG. 6), requests the controller 41 (see FIG. 6) to generate dummy image information for light intensity correction. The controller 41 (see FIG. 6) generates the dummy image information for light intensity correction based on the request, and lightening of the organic electroluminescence device of the exposure device 13 is actually controlled at the time of initialization based on the generated dummy image information. In the second embodiment, at this time, the light detecting device 120 of the exposure device 13 measures the light intensity of the organic electroluminescence device 110 (see FIG. 9A) and corrects the light intensity, based on a result of the measurement of the light intensity, such that light intensities of individual organic electroluminescence devices 110 become substantially equal to each other. The light intensity measurement is made under a state where units related to image formation, such as the photoconductor 8 and the developing stations 2Y to 2K of the image forming apparatus 1, are driven, as described above. This is because, if the light intensity is measured under a state where the rotation of the photoconductor 9 stops, the same portion of the photoconductor 8 is continuously exposed into a so-called light divulgence, which results in local deterioration of a characteristic of the photoconductor 8. Accordingly, the light intensity measurement is made at least under a state where the charger 9 charges the photoconductor 8 in order to prevent the toner from being adhered to the photoconductor 8, while rotating the photoconductor 8.

### <Image Forming Operation>

Next, an image forming operation of the image forming apparatus 1 will be described with reference to FIGS. 6 and 7.

When image information is transmitted to the controller 41 externally, the controller 41 expands the image information, for example, as printable binary image data, into an image memory (not shown). Upon completing the expansion of the image information, the controller CPU (not shown) of the controller 41 requests the engine controller 42 to start. This starting request is received in the engine control CPU (not shown) of the engine controller 42, and the engine control CPU (not shown) that received the starting request begins to prepare for image formation by immediately rotating the driving source 38.

The above process is the same as the above-described <initialization operation> except the error check related to the electrical resources, and the engine control CPU (not shown) can measure the light intensity even at this point of time. However, since the light intensity measurement needs time of 10 seconds or so, as will be described later, the light intensity measurement has an effect on a first print time (time taken to print a first sheet of paper). Accordingly, whether or not the light intensity is corrected at the time of starting may be determined according to a user's instruction inputted through an operation panel (not shown) or from the outside (for example, a computer) of the image forming apparatus 1.

When the preparation for the image formation is completed through the above-described process, the engine control CPU (not shown) of the engine controller 42 controls the electromagnetic clutch (not shown) and starts to carry the recording paper 3 by rotating the feeding roller 18. The feeding roller 18, which is, for example, a half-moon type roller having a semicircumference, carries the recording paper 3 toward the resist roller 19, and stops after rotating once. When the lead end of the carried recording paper 3 is detected by the recording paper passage detecting sensor 21, the engine control CPU (not shown) sets a predetermined delay time and controls the electromagnetic clutch (not shown) to rotate the resist roller 19. With the rotation of the resist roller 19, the recording paper 3 is supplied to the recording paper carrying path 5.

The engine control CPU (not shown) controls a write timing of the electrostatic latent image formed by the exposure devices 13Y to 13K independently, with a rotation initiation timing of the resist roller 19 as a starting point. Since the write timing of the electrostatic latent image has a direct effect on color miss-convergence and so on in the image forming apparatus 1, the engine control CPU (not shown) does not directly generate the write timing. Specifically, the engine control CPU (not shown) presets write timings of the electrostatic latent image formed by the exposure devices 13 in timers (not shown) and starts operation of the timers corresponding to the exposure devices 13Y to 13K simultaneously, with the rotation initiation timing of the resist roller 19 as the starting point. When a time preset in each timer elapses, an image data transmission request is outputted to the controller 41.

The controller CPU (not shown) of the controller 41 that received the image data transmission request transmits binary image data to the exposure devices 13Y to 13K independently in synchronization with a timing signal (a clock signal, a line synchronization signal, etc.) generated in a timing generating part (not shown) of the controller 41. In this manner, the binary image data are transmitted to the exposure devices 13Y to 13K, and the lightening on/off of the organic electroluminescence devices of the exposure devices 13Y to 13K is controlled based on the binary image data such that the photoconductors 8Y to 8K corresponding to respective colors are exposed.

The latent image formed by the exposure is developed by the toner contained in the developer 6 supplied on the developing sleeve 10, as shown in FIG. 7. Developed toner images of respective colors are sequentially transferred onto the recording paper 3 carried by the recording paper carrying path 5. The recording paper 3 onto which the four color toner images are transferred is carried to the fixer 23 and then is held and carried by the heating roller 24 and the pressurizing roller 25 of the fixer 23. The toner images are fixed on the recording paper 3 by heat and pressure by the heating roller 24 and the pressurizing roller 25.

If an image is to be formed on a plurality of pages of paper, the engine control CPU (not shown) detects a trailing end of a first page of the recording paper 3 by means of the recording paper passage detecting sensor 21, pauses the rotation of the resist roller 19, carries a next page of the recording paper 3 by rotating the feeding roller 18 after lapse of a predetermined period of time, and then supplies the next page to the recording paper carrying path 5 by again rotating the resist roller 19 after lapse of a predetermined period of time. When the image is formed on the plurality of pages of the recording paper 3 according to the timing control of rotation ON/OFF of the resist roller 19, a paper interval between the plurality of pages may be set. Time corresponding to the paper time (hereinafter referred to as paper interval time) depends on the specification of the image forming apparatus 1. In general, the paper interval time is set to be 500 ms or so. Of course, the image forming operation (that is, the exposure operation of the exposure device 12 for the photoconductor 13) will not be performed during the paper interval time.

When the image forming apparatus 1 of the invention performs the image forming operation for the plurality of pages, the intensity of light emitted from the light emitting devices (the organic electroluminescence devices) of the exposure device 13 is measured for a period of time corresponding to each page (paper interval time). At this time, the light intensity is controlled to be lower than that for typical image formation, as described in the <initialization operation>, such that it can not contribute to developing.

As described above, in the second embodiment, the paper interval time is 500 ms or so. As will be described later, in the second embodiment, time required to measure the light intensity for all of the organic electroluminescence devices is about 10 seconds, as mentioned in the <initialization operation>. That is, the light intensity of all of the organic electroluminescence devices can not be measured during the paper interval time of 500 ms. Accordingly, in the second embodiment, when the light intensity of the organic electroluminescence devices is measured for a period of time corresponding to each page, the light intensity of some of the organic electroluminescence devices of the exposure device 13 is measured.

Assuming that the paper interval time is 500 ms and the measurement time of the light intensity is 10 seconds or so, when the number of the paper intervals is 20, the light intensity of all of the organic electroluminescence devices of the exposure device 13 can be measured according to simple calculation. Of course, the number of pages in a series of print jobs may be often less than 20. In this case, the light intensity may be measured after the series of print jobs is completed (that is, when the image forming apparatus 1 goes into a standby mode where it waits a print instruction).

FIG. 8 is a view showing a configuration of the exposure device 13 in the image forming apparatus 1 according to the second embodiment of the invention.

Hereinafter, the structure of the exposure device 13 will be described in detail with reference to FIG. 8. In FIG. 8, a reference numeral 100 denotes a colorless transparent glass substrate.

Organic electroluminescence devices as light emitting devices are formed with resolution of 600 dpi (dot/inch) on a surface A of the glass substrate 100 in a direction perpendicular to the figure (a main scan direction). A reference numeral 51 denotes a lens array including bar lenses (not shown) that are made of plastic or glass and are arranged in the form of a row. The lens array 51 leads light, which is emitted from the organic electroluminescence devices formed on the surface A of the glass substrate 100, to a surface of the photoconductor 8 to form an erect image with unit magnification.

A reference numeral 52 denotes a relay board comprised of, for example, an epoxy substrate and an electronic circuit formed on the epoxy substrate. Reference numerals 53a and 53b denote a connector A and a connector B, respectively. At least the connectors A and B 53a and 53b are mounted on the relay board 52. The relay board 52 relays, image data, light intensity correction data and other control signals, which are supplied from the outside to the exposure device 13 through a cable 56 such as a flexible flat cable, via the connector B 53B, and transmits these data and signals to the glass substrate 100.

In consideration of bond strength and reliability in different environments, since it is difficult to directly mount the connectors on the surface of the glass substrate 100, a flexible printed circuit (FPC) (not shown) is employed as a means connecting the connector A 53a of the relay board 52 to the glass substrate 100. For example, the FPC is directly bonded to an indium thin oxide (ITO) electrode, for example, formed in advance on the glass substrate 100 using, for example, an anisotropic conductive film (AFC).

On the other hand, the connector B 53b is a connector for connecting the exposure device 13 to the outside. In general, the connection by the ACF has somewhat weak bonding strength. However, when a user arranges the connector B 53b for connection of the exposure device 13 on the relay board 52, strength sufficient for an interface accessed directly by the user can be secured.

A reference numeral 54a denotes a housing A that is shaped by, for example, bending a metal plate. An L-like portion 55 is formed at a side opposite to the photoconductor 8 in the housing A 54a, and the glass substrate 100 and the lens array 51 are arranged along the L-like portion 55. By employing a structure where an edge of the photoconductor 8 of the housing A 54a and an edge of the lens array 51 are put on the same plane and one end of the glass substrate 100 is supported by the housing A 54a, it is possible to set a positional relation between the glass substrate 100 and the lens array 51 with high precision if the shaping precision of the L-like portion 55 is secured. Since the housing A 54a requires high dimension precision as described above, it is preferable that the housing A 54a is made of metal. In addition, when the housing A 54a is made of metal, it is possible to prevent a control circuit formed on the glass substrate 100 and electronic components such as an IC chip mounted on the surface of the glass substrate 100 from being affected by noises.

A reference numeral 54b denotes a housing B obtained by shaping resin. A notch (not shown) is formed near the connector B 53b of the housing B 54b. The notch allows a user to access the connector B 53b. The image data, the light intensity correction data, the control signal such as the clock signal or the line synchronization signal, the driving power of the control circuit, the driving power of the organic electroluminescence devices as the light emitting devices, etc. are supplied from the above-described controller 41 (see FIG. 6) to the exposure device 13 via the cable 56 connected to the connector B 53b.

FIG. 9A is a top view of the glass substrate 100 related to the exposure device 13 in the image forming apparatus 1 according to the second embodiment of the invention, and FIG. 9B is an enlarged view of a main portion of the glass substrate 100.

Hereinafter, a configuration of the glass substrate 100 according to the second embodiment will be described in detail with reference to FIGS. 9A and 9B in conjunction with FIG. 8.

As shown in FIGS. 9A and 9B, the glass substrate 100 is an about 0.7 mm thick rectangular substrate having at least long sides and short sides. A plurality of organic electroluminescence devices 110 as light emitting devices is formed in a row in a long side direction of the glass substrate 100. In the second embodiment, the organic electroluminescence device 110 required for exposure of at least an A4 size (210 mm) are arranged in the long side direction of the glass substrate 100. The length of the long side direction of the glass substrate 100 is 25 mm, including an arrangement space of a driving controller 58 which will be described later. Although it is illustrated in the second embodiment that the glass substrate 100 has a rectangular shape for the sake of simplification, the glass substrate 100 may be such modified that the glass substrate 100 has partially a notch in order to position the glass substrate 100 in the housing A 54a.

A reference numeral 58 denotes a driving controller that receives the binary image data, the light intensity correction data and the control signal such as the clock signal or the line synchronization signal, which are supplied from the outside of the glass substrate 100, and controls the driving of the organic electroluminescence devices 110 based on these data and signals. The driving controller 58 includes an interface means that receives these data and signals from the outside and an IC chip (source driver 61) that controls the driving of the organic electroluminescence devices 110 based on the control signal received via the interface means.

A reference numeral 60 denotes a flexible print circuit (FPC) as an interface means that connects the connector A 53a of the relay board 52 to the glass substrate 100. The FPC 60 is directly connected to a circuit pattern (not shown) formed on the glass substrate 100 without via the connector or the like. As described above, the binary image data, the light intensity correction data, the control signal such as the clock signal or the line synchronization signal, the driving power of the control circuit, and the driving power of the organic electroluminescence devices as the light emitting devices, which are supplied from the outside to the exposure device 13, are transmitted to the glass substrate 100 via the relay board 52 and then the FPC 60.

A reference numeral 110 denotes the organic electroluminescence devices that are exposure light sources of the exposure device 13. In the second embodiment, 5120 organic electroluminescence devices 110 are formed with resolution of 600 dpi in a row in a main scan direction, and lightening on/off of the organic electroluminescence devices are independently controlled by a TFT circuit which will be described later.

A reference numeral 61 denotes the source driver that is provided as an IC chip for controlling the driving of the organic electroluminescence devices 110 and is flip chip-mounted on the glass substrate 100. The source driver 61 employs a bare chip product in consideration of surface mount with glass. The source driver 61 is supplied with power, a control-related signal such as a clock signal and a line synchronization signal, and 8 bit light intensity correction data from the outside of the exposure device 13 via the FPC 60. The source driver 61 is a driving current setting means for the organic electroluminescence device 110. More specifically, based on the light intensity correction data generated by the controller CPU (not shown) of the controller 41 (see FIG. 6) which is the light intensity correcting means and simultaneously the light intensity setting means of the organic electroluminescence devices 110, the source driver 61 sets driving current for driving the organic electroluminescence devices 110. An operation of the source driver 61 based on the light intensity correction data will be described in detail later.

In the glass substrate 100, a bonding portion of the FPC 60 is connected to the source driver 61 via a circuit pattern (not shown) of ITO on which surface is formed with metal, and the source driver 61 as the driving current setting means is inputted with the light intensity correction data and the control signal such as the clock signal and the line synchronization signal via the FPC 60. In this manner, the FPC 60 as an interface means and the source driver 61 as a driving parameter setting means constitutes the driving controller 58.

A reference numeral 62 denotes a thin film transistor circuit formed on the glass substrate 100. The TFT circuit 62 includes a shift register, a data latch, a gate controller (not shown) that controls a timing of lightening on/off of the organic electroluminescence devices 110, and a driving circuit 160 that supplies driving current to the organic electroluminescence devices 110 (see FIG. 1). In addition, the driving circuit 160 is included in a pixel circuit 69 (which will be described later with reference to FIG. 13). A plurality of driving circuits 69 is provided in correspondence to the organic electroluminescence devices 110, and is arranged in parallel to the light emitting device array constituted by the organic electroluminescence devices 110. The source driver 61 as the driving parameter setting means sets driving current values for driving the organic electroluminescence devices in the pixel circuits.

The gate controller (not shown) of the TFT circuit 62 is supplied with the power, the control signal such as the clock signal and the line synchronization signal, and the binary image data from the outside of the exposure device 13 via the FPC 60, and controls the lightening on/off timing of the light emitting devices based on the power, signal and data. Operations of the gate controller (not shown) and the pixel circuits (not shown) will be described in detail later with reference to the drawings.

A reference numeral 62a also denotes a thin film transistor (TFT) circuit formed on the glass substrate 100. The TFT circuit 62a includes a set of select transistors 130 (see FIG. 1) which have been described in detail in the first embodiment.

A reference numeral 64 denotes sealing glass. If water permeates into the organic electroluminescence devices 110, their emission characteristic may be extremely deteriorated due to shrinking of light emission regions with time or non-light emission portions (dark spots) occurring in the light emission region. Accordingly, it is necessary to seal the organic electroluminescence devices 110 in order to prevent water from permeating into the organic electroluminescence devices 110. The second embodiment employs a beta sealing method in which the sealing glass 64 is adhered to the glass substrate 100 by means of an adhesive. In this case, in general, there is a need of a sealing region of 2000 μm length in a sub scan direction from the light emitting device array constituted by the organic electroluminescence devices 110. In the second embodiment, 2000 μm is secured as a sealing margin.

As shown in FIG. 9, the sealing glass 64 is adhered to the glass substrate 100 by means of an adhesive 63. The sealing glass 64 completely coats the TFT circuit 62a including the set of select transistors 130 and partially coats some of the TFT circuit 62 including a set of driving circuits of the organic electroluminescence devices 110. Of course, the TFT circuit 62 may be completely coated with the sealing glass 64. By completely coating the TFT circuit 62a with the adhesive 63 and the sealing glass 64, it is prevented that cracks occur in the TFT circuit 62a when the glass substrate 100 is cut out (diced) from mother glass in a process of manufacturing exposure devices, thereby increasing a yield. The sealing and dicing operations are will be described later.

The light detecting devices 120 which have been described in the first embodiment are arranged on the glass substrate 100 in the main scan direction along the long side of the glass substrate 100. A reference numeral 59 denotes the processing circuit including at least the charge amplifier 150 and the AD converter 240 (see FIG. 3). The light detecting devices 120 measure the light intensity of the organic electroluminescence devices 110. In principle, after the organic electroluminescence devices are individually lightened on, light intensity of each of the organic electroluminescence devices need to be measured. However, if the light detecting devices 120 are distant from the organic electroluminescence devices 110 to be measured, light emitted from the organic electroluminescence devices have little effect on the light detecting devices 120. Accordingly, the second embodiment makes it possible to measure the light intensity of the organic electroluminescence devices 110 simultaneously by arranging the light detecting devices 120 in correspondence to the individual organic electroluminescence devices 110.

Outputs of the plurality of light detecting devices 120 are inputted ti the processing circuit 59 via wirings (not shown). The processing circuit 59 is an analog/digital-mixed IC chip. The outputs of the light detecting devices 120 are voltage-converted by a charge accumulating method in the processing circuit 59, amplified with a predetermined amplification ratio, and then converted into digital data. The digital data (hereinafter referred to as light intensity measurement data) are outputted to the outside of the exposure device 13 via the FPC 60, the relay board 52 and the cable 56 (see FIG. 8). As will be described later, the light intensity measurement data are received and processed in the controller CPU (not shown) of the controller 41 (see FIG. 6) to generate 8-bit light intensity correction data.

FIG. 10 is a block diagram showing a configuration of the controller 41 in the image forming apparatus 1 according to the second embodiment of the invention.

Hereinafter, an operation of the controller 41 and the light intensity correction will be described in detail with reference to FIG. 10.

In FIG. 10, a reference numeral 80 denotes a computer. The computer 80 transmits image information and print job information such as the number of print papers and print mode (for example, color/monochrome) to the controller 41 via a network 81 connected to the computer 80. A reference numeral 82 denotes a network interface. The controller 41 receives the image information and the print job information transmitted from the computer 80 via the network interface 82, expands the image information to printable binary image data, and transmits information on errors detected in the image forming apparatus, as so-called status information, to the computer 80 via the network 81.

A reference numeral 83 denotes the controller CPU that controls an operation of the controller 41 based on a program stored in a ROM 84. A reference numeral 85 denotes a RAM that is used as a work area of the controller CPU 83 and in which the image information and the print job information received via the network interface 82 are temporarily stored.

A reference numeral 86 denotes an image processing part. The image processing part 86 performs an image process (for example, image expansion based on a print language, color correction, edge correction, screen creation, etc.) in the unit of page, based on the image information and the print job information transmitted from the computer 80, to generate the printable binary image data which are stored in the image memory 65 in the unit of page.

A reference numeral 66 denotes a light intensity correction data memory constituted by a rewritable nonvolatile memory such as an EEPROM.

FIG. 11 is an explanatory view illustrating contents of a light intensity correction data memory in the image forming apparatus 1 according to the second embodiment of the invention.

Hereinafter, a data structure and data contents of the light intensity correction data memory will be described with reference to FIG. 11.

As shown in FIG. 11, the light intensity correction data memory 66 has three areas including first to third areas. Each area includes 5120 8-bit data which are the same number as the organic electroluminescence devices 110 (see FIG. 9) of the exposure device 13 (see FIG. 8). Accordingly, the three areas occupy the total of 15360 bytes.

First, data DD[0] to DD[5119] stored in the first area will be described with reference to FIG. 11 in conjunction with FIGS. 8 and 9.

The manufacturing process of the above-described exposure device 13 (see FIG. 8) includes the process of adjusting the light intensity of the organic electroluminescence devices 110 (see FIG. 9) of the exposure device 13. In the light intensity adjustment process, the exposure device 13 is mounted on a jig (not shown), and the organic electroluminescence devices 110 are individually controlled to be lightened on/off base on a control signal supplied from the outside of the exposure device 13.

In addition, a CCD camera provided in the jig (not shown) measures a two-dimensional light intensity distribution of the individual organic electroluminescence devices 110 at an image plane of the photoconductor 8 (see FIG. 8). The jig (not shown) calculates a potential distribution of a latent image formed on the photoconductor 8 based on the light intensity distribution and also calculates a latent image cross section having high correlation with the amount of attachment of toner based on actual developing conditions (developing bias values). The jig (not shown) changes a driving current value for driving the organic electroluminescence devices 110 {as described above, a current value for driving the organic electroluminescence devices 110 can be set by programming analog values into the pixel circuit of the TFT circuit 62 (see FIG. 9) through the source driver 61 (see FIG. 9)}, and extracts a driving current value that makes all latent image cross sections formed by the organic electroluminescence devices 110 substantially equal to each other, that is, a setting value set in the pixel circuit (setting data set into the source driver 61 from a control standpoint).

However, when light emission areas and light intensity distributions in light emission planes of the organic electroluminescence devices 110 are equal to each other and typical developing conditions are assumed, the above-described latent image cross section is substantially in proportion to the light intensity. Moreover, since “light intensity for a constant period of time” has the same meaning as “exposure amount” and the light intensity of the organic electroluminescence devices 110 is typically in proportion to the driving current value (that is, the setting value set in the pixel circuit), by making driving current settings in all of the pixel circuits equal to each other and measuring the light intensity of the organic electroluminescence devices 110 once, it is possible to calculate a setting value set in the pixel circuit (as described above, setting data set into the source driver 61) that makes all latent image cross sections formed by the organic electroluminescence devices 110 equal to each other.

The above-obtained setting data set in the source driver 61 are stored in the first area of the light intensity correction data memory 66. The number of setting data is 5120 which is the same number as the organic electroluminescence devices 110 (that is, the same number as pixel circuits) of the exposure device 13. In this manner, “setting values of the source driver 61 that make the latent image cross sections formed by the organic electroluminescence devices 110 equal to each other in an initialization state” are stored in the first area of the light intensity correction data memory 66.

Next, data ID[0] to ID[5119] stored in the second area will be described with reference to FIG. 11 in conjunction with FIGS. 8 and 9.

The jig acquires the data stored in the first area and acquires the 8-bit light intensity measurement data based on the outputs of the light detecting devices 120 (see FIG. 9) through the processing circuit 59 (see FIG. 9) of the exposure device 13. Thus, “light intensity measurement data when the latent image cross sections formed by the organic electroluminescence devices 110 in an initialization state are equal to each other” can be acquired. The 8-bit light intensity measurement data ID[n] are stored in the second area.

By the way, it is necessary to make driving conditions of the organic electroluminescence devices 110 when the jig acquires the data ID[n] equal to driving conditions when the light intensity is measured. In the second embodiment, as will be described later, by applying a one-line period (raster period) of 350 μs of the image forming apparatus 1 many times, the total of lightening time of about 30 ms is given.

In this manner, the data stored in the first and second areas are acquired in the process of manufacturing the exposure device 13, and are written into the light intensity correction data memory 66 from the jig by means of an electrical communicating means (not shown).

Next, data ND[0] to ND[5119] stored in the third area will be described with reference to FIG. 11 in conjunction with FIGS. 8, 9 and 10.

In the image forming apparatus 1 according to the second embodiment of the invention, the light intensity correcting means {controller CPU 83 (see FIG. 10)} corrects light intensities of the organic electroluminescence devices 110 to be substantially equal to each other based on a result of the measurement by the light detecting devices 120 as the light intensity measuring means, and the light intensity setting means (the same controller CPU 83) sets the light intensity of organic electroluminescence devices 110 when an image is formed, based on an output from the light intensity correcting means. Setting values of the light intensity of the organic electroluminescence devices 110 when an image is formed, that is, the light intensity correction data, are written into the third area by the controller CPU 83 as the light intensity correcting means.

As described above, in the image forming apparatus 1 of the second embodiment, the light intensity of the organic electroluminescence devices 110 of the exposure device 13 is measured in the initialization operation of the image forming apparatus 1, starting of the image forming operation, paper interval, completion of the image forming operation, etc. The controller CPU 83 generates the light intensity correction data based on the light intensity measurement data measured at these points of time, “the setting values of the source driver 61 that make the latent image cross sections formed by the organic electroluminescence devices 110 equal to each other in an initialization state” stored in the first area in the process of manufacturing the exposure device 13, and “the light intensity measurement data when the latent image cross sections formed by the organic electroluminescence devices 110 in an initialization state are equal to each other” stored in the second area in the process of manufacturing the exposure device 13.

Hereinafter, calculation of the light intensity correction data by the controller CPU 83 will be described. In the following description, it is assumed that light intensity in measuring the light intensity is equal to light intensity in forming an image for the sake of clarifying the point of the invention.

Assuming that “the setting values of the source driver 61 that make the latent image cross sections formed by the organic electroluminescence devices 110 equal to each other in an initialization state” stored in the first area are DD[n] (n is an organic electroluminescence device number in the main scan direction, the same as above), “the light intensity measurement data when the latent image cross sections formed by the organic electroluminescence devices 110 in an initialization state are equal to each other” stored in the second area are ID[n], and light intensity correction data newly measured in the initialization operation and so on are PD[n], new light intensity correction data ND[n] written into the third area are generated by the controller CPU 83 according to the following equation 1.

ND[n]=DD[n]×ID[n]/PD[n] (where, n is an organic electroluminescence device number in the main scan direction) [Equation 1]

Equation 1 is the principle equation for light intensity correction data calculation that is applied when the light intensity in forming the image is equal to the light intensity in measuring the light intensity, as described above. In the second embodiment, the light intensity of the organic electroluminescence devices 110 in the light intensity measurement related to the light intensity correction is set to be smaller than the light intensity in the image formation. To this end, when the light intensity is measured, the DD[n] as light intensity correction data to be transmitted to the exposure device 13 are multiplied by a constant k smaller than 1, and the organic electroluminescence devices 110 are lightened on based on the light intensity correction data. For example, when the light intensity correction data DD[n] multiplied by k of, for example, 0.5 are programmed into the pixel circuit (not shown) through the source driver 61 (see FIG. 9), as described above, the organic electroluminescence devices 110 can emit light with intensity (in the unit of cd/m²) which corresponds to ½ of the light intensity in the image formation. At this time, new light intensity correction data ND[n] may be generated according to the following equation 2.

ND[n]=DD[n]×(ID[n]×k)/PD[n] (where, n is an organic electroluminescence device number in the main scan direction and k is a constant smaller than 1) [Equation 2]

The generated light intensity correction data ND[n] are written into the third area of the light intensity correction data memory 66 (see FIG. 10). Thereafter, prior to image formation, the light intensity correction data ND[n] are copied from the light intensity correction data memory 66 into an area of the image memory 65 (see FIG. 10). For the image formation, the light intensity correction data ND[n] copied into the image memory 65 are temporarily stored in a buffer memory 88 (see FIG. 10), which will be described later, along with binary image data, and then are outputted to the engine controller 42 (see FIG. 10) via a printer interface 87 (see FIG. 10).

The light intensity measurement data are voltage-converted by a charge accumulating method in the processing circuit 59 (see FIG. 9). The charge accumulating method is effective in improving a SN ratio, but since the output (current value) of the light detecting device 120 is very small, it takes a time to accumulate charges. In the second embodiment, by setting an accumulation time to be 300 ms or so, the SN ratio of 48 Db is secured for the light intensity measurement. However, when the accumulating time is set to be 300 ms, it takes a long time to measure the light intensity. When light intensities of 5120 organic electroluminescence devices 110 (see FIG. 9) are measured one by one, it take 154 seconds (=5120×30 ms) to measure all the light intensities of the organic electroluminescence devices 110, which is inefficient on a practical point of view. Accordingly, in the second embodiment, polycrystalline silicon sensors, as the light detecting devices 120, which are integrated on the glass substrate 100, are divided into 16 groups, and charges are simultaneously accumulated in the unit of group, and then, a terminal voltage of the light detecting device 120 is measured. Accordingly, the measurement can be made at a high speed while suppressing a cross-talk between the light detecting devices 120. As a result, it takes 9.6 seconds (=154/16) to measure the light intensity.

Returning to FIG. 10, the operation of the controller 41 will be continuously described.

A reference numeral 88 denotes a buffer memory. The binary image data and the light intensity correction data stored in the image memory 65 are stored in the buffer memory 88 for transmission to the engine controller 42. The buffer memory 88 is comprised of a so-called dual port RAM to absorb a difference between a data transmission rate from the image memory 65 to the buffer memory 88 and a data transmission rate from the buffer memory 88 to the engine controller 42.

A reference numeral 87 denotes a printer interface. The binary image data and the light intensity correction data stored in the unit of page in the image memory 65 are transmitted to the engine controller 42 via the printer interface 87 in synchronization with the clock signal or the line synchronization signal generated by the timing generating part 67.

FIG. 12 is a block diagram showing a configuration of the engine controller 42 in the image forming apparatus 1 according to the second embodiment of the invention.

Hereinafter, an operation of the engine controller 42 will be described in detail with reference to FIG. 12 in conjunction with FIG. 6.

In FIG. 12, a reference numeral 90 denotes a controller interface. The controller interface 90 receives the light intensity correction data, the binary image data in the unit of page, etc. transmitted from the controller 41.

A reference numeral 91 denotes an engine control CPU that controls the image forming operation in the image forming apparatus 1 based on a program stored in a ROM 92. A reference numeral 93 denotes a RAM that is used as a work area when the engine control CPU 91 operates. A reference numeral 94 denotes a so-called rewritable nonvolatile memory such as EEPROM. The nonvolatile memory 94 is stored with information related to lifetime of components, such as rotation time of the photoconductor 8 of the image forming apparatus 1, operation time of the fixer 23 (see FIG. 6) and so on.

A reference numeral 95 denotes a serial interface. Information from a group of sensors including the recording paper passage detecting sensor 21 (see FIG. 6) and the recording paper trailing end detecting sensor 28 (see FIG. 6) or an output from the power monitor 44 (see FIG. 6) is converted into a serial signal having a predetermined period by a serial converting means (not shown), and then is received in the serial interface 95. The serial signal received in the serial interface 95 is converted into a parallel signal and then is read in the engine control CPU 91 via a bus 99.

On the other hand, a control signal to an actuator group 96 such as the electromagnetic clutch (not shown) that controls start/stop of the feeding roller 18 (see FIG. 6) and the driving source (see FIG. 6) and transmission of driving force to the feeding roller 18 (see FIG. 6), or a control signal to a high voltage power controller 97 that manages setting of a developing bias, a transfer bias, a charging potential, etc. is transmitted, as a parallel signal, to the serial interface 95. The serial interface 95 converts the parallel signal into a serial signal to be outputted to the actuator group 96 and the high voltage power controller 97. In this manner, in the second embodiment, sensor input signals and actuator control signals, which do not need to be detected at a high speed, are outputted via the serial interface 95. On the other hand, a control signal to drive/stop the resist roller 19, for example, which has to operate at a high speed, is directly inputted to an output terminal of the engine control CPU 91.

A reference numeral 98 denotes an operation panel connected to the serial interface 95. An instruction from a user through the operation panel 98 is recognized by the engine control CPU 91 via the serial interface 95. In the second embodiment, based on the instruction from the user through the operation panel 98 as an instruction input means, the light intensity of the organic electroluminescence devices 110 of the exposure device 13 is measured and corrected. Of course, it is also possible to input an instruction from an external computer or the like via the controller 41. Specifically, for example when a large quantity of paper is printed, if a user finds concentration spots in a printed paper, he/she may instruct light intensity to be corrected, thereby improving image quality. While the image forming apparatus 1 is in a standby state, a user may instruct light intensity to be corrected at any times. Even while an image is formed, a user may transit the image forming apparatus to an off line to stop the image forming operation and then instruct light intensity to be correct.

In any case, when a light intensity correction request is inputted from the operation panel 98 as the instruction input means or the like, as described in the <initialization operation>, the engine control CPU 91 starts driving of the components of the image forming apparatus 1 and requests the controller 41 to generate the dummy image information for light intensity correction. The controller CPU 83 of the controller 41 generates the dummy image information for light intensity correction based on the request, and lightening of the organic electroluminescence devices 110 of the exposure device 13 is controlled based on the generated dummy image information. At this time, the light detecting device 120 of the exposure device 13 detects light intensities of the organic electroluminescence devices 110 and corrects the light intensities of the organic electroluminescence devices 110, based on a result of the detection of the light intensities, such that the light intensities of individual organic electroluminescence devices 110 become substantially equal to each other.

Next, an operation of measuring the light intensity of the organic electroluminescence devices 110 will be described with reference to FIG. 12 in conjunction with FIGS. 6, 10 and 11.

As described above, although the light intensity is corrected in the initialization operation immediately after starting of the image forming apparatus 1, before print starting, in paper interval, after print starting, at the time of input of the instruction from the user through the operation panel 98, etc., a case where the light intensity is measured in the initialization operation of the image forming apparatus 1 will be described for the sake of simplification of description. Similarly, although the image forming apparatus 1 of the second embodiment can form a full color image and have the exposure devices 13Y to 13K (see FIG. 6) corresponding to four colors as described above, only an operation for one color like the exposure device 13 will be described for the sake of simplification of description. In addition, in the following description, it is assumed that, for example, the driving source 38 (see FIG. 6) or the developing station 2 (see FIG. 7) has already started as described in the <initialization operation>.

Since it is the engine controller 42 that manages the image forming operation in the image forming apparatus 1, a sequence of light intensity correction is started by the engine control CPU 91 of the engine controller 42. First, the engine control CPU 91 requests the controller 41 to generate dummy image information different from the normal binary image data related to the image formation.

The engine controller 42 and the controller 41 are interconnected by a bi-directional serial interface (not shown) and can exchange a request command and acknowledge (response information) to the request command. The request to generate the dummy image information, which is outputted from the engine control CPU 91, is transmitted from the controller interface 90 to the controller 41 via the bus 99 using the bi-directional serial interface (not shown).

Based on the request, the controller CPU 83 of the controller 41 directly writes the dummy image information, that is, the binary image data used for the light intensity measurement, into the image memory 65. In addition, the controller CPU 83 reads DD[n] (n: 0˜5199) which are “the setting values of the source driver 61 that make the latent image cross sections formed by the organic electroluminescence devices 110 equal to each other in an initialization state” stored in the first area (see FIG. 6) of the light intensity correction data memory 66, multiplies the read DD[n] by a constant (for example, 0.5) smaller than 1, and sets the light intensity of the organic electroluminescence devices 110 to be lower than the light intensity in the typical image forming operation. Then, a resultant value is written into a predetermined area of the image memory 65. Thereafter, the controller CPU 83 outputs response information to the engine controller 42 via the printer interface 87.

The engine control CPU 91 of the engine controller 42 which received the response information immediately sets a write timing for the exposure device 13. That is, the engine control CPU 91 sets the write timing of the electrostatic latent image formed by the exposure device 13 in a timer (not shown) and begins to operate the timer immediately upon receiving the response information (This function is originally for deciding a starting timing for each of the exposure devices 13 having different colors. Such a strict timing setting is not required for light intensity measurement. For example, the timer may be set to be 0). When a preset time elapses, the timer outputs an image data transmission request to the controller 41. The controller 41 that received the image data transmission request transmits the binary image data to the exposure device 13 in synchronization with the timing signal (the clock signal, the line synchronization signal, etc.) generated in the timing generating part 67 via the controller interface 90. At the same time, “the setting value of the light intensity which is set to be lower than that in the typical image forming operation” stored in the image memory 65 is also transmitted to the exposure device 13 in synchronization with the timing signal. In addition, in the typical image forming operation, instead of “the setting value of the light intensity which is set to be lower than that in the typical image forming operation,” the light intensity correction data (ND[n]) are supplied to the exposure device 13 via the same transmission path.

In this manner, the binary image data transmitted in synchronization with the timing signal is inputted to the TFT circuit 62 of the exposure device 13, and at the same time, the setting value of the light intensity is inputted to the source driver 61 of the exposure device 13. The exposure device 13 controls lightening on/off of the organic electroluminescence devices 110 based on the inputted binary image data, that is, ON/OFF information. At this time, the organic electroluminescence devices 110 emit light with intensity lower than that in the typical image forming operation based on the setting value of the light intensity. Then, the light intensity of the organic electroluminescence device 110 is measured by the light detecting device 120.

In the light intensity measuring operation by the light detecting devices 120, the lightening of the organic electroluminescence devices 110 is such controlled that a cross-talk is prevented. The outputs (analog current values) of the light detecting devices 120 are converted into a voltage by a charge accumulating method in the processing circuit 59, amplified with a predetermined amplification ratio, and then converted into digital data. The digital data are outputted, as the 8-bit light intensity measurement data (digital data), from the processing circuit 59.

The light intensity measurement data outputted from the processing circuit 59 are transmitted from the engine controller 42 to the controller 41 via the controller interface 90 and is received in the controller CPU 83 of the controller 41. The controller CPU 83 generates the light intensity correction data ND[n] using the light intensity measurement data as PD[n] in Equation 2.

FIG. 13 is a circuit diagram of the exposure device 13 in the image forming apparatus 1 according to the second embodiment of the invention.

Hereinafter, a control of lightening on/off operation by the TFT circuit 62 and the source driver 61 will be described in more detail with reference to FIG. 13.

The TFT circuit 62 is generally divided into the pixel circuits 69 and the gate controller 68. The pixel circuits 69 are arranged in correspondence to the individual organic electroluminescence devices 110, and N groups of organic electroluminescence devices 110, with M pixels as one group, are arranged on the glass substrate 100.

In the second embodiment, the total number of groups of organic electroluminescence devices 110 is 640, with 8 pixels (M=8) as one group. Accordingly, the total number of pixels is 5120 (=8×640). Each pixel circuit 69 includes a driver part 70 that drives organic electroluminescence devices 110 by supplying current to the organic electroluminescence devices 110, and a so-called current program part 71 that stores a current value supplied by the driver part 70 (that is, a driving current value of the organic electroluminescence devices 110) in an internal condenser in controlling the lightening on/off of the organic electroluminescence devices 110. The organic electroluminescence devices 110 can be driven with constant current depending on the driving current value programmed with a predetermined timing.

The gate controller 68 includes a shift register (not shown) that shifts the inputted binary image data sequentially, a latch (not shown) that is arranged in parallel to the shift register and collectively maintains the number of pixels inputted to the shift register, and a controller (not shown) that controls operation timings of the shift register and the latch. The gate controller 68 receives the binary image data (the image information converted by the controller 41 in the image forming operation, and the dummy image information converted by the controller 41 in the light intensity measuring operation) from the controller 41, and outputs SCAN_A and SCAN_B signals based on the received binary image data, that is, the ON/OFF information, and controls timings of a lightening on/off interval of the organic electroluminescence devices 110 connected to the pixel circuits 69 and a current program interval at which driving current is set, based on the outputted SCAN_A and SCAN_B signals.

On the other hand, the source driver 61 has the number (640 in the second embodiment) of D/A converters 72 corresponding to the number (N) of groups of organic electroluminescence devices 110. The source driver 61 sets the driving current for the organic electroluminescence devices 110 based on the 8-bit light intensity correction data (ND[n] shown in FIG. 11 in the image forming operation, and a product of DD[n] shown in FIG. 11 and a constant k smaller than 1 in the light intensity measuring operation) supplied via the FPC 60. With this configuration, the light intensity of the organic electroluminescence devices 110 is uniformly controlled based on the light intensity correction data ND[n] in the image forming operation, and the light intensity of the organic electroluminescence devices 110 is controlled in the light intensity measuring operation such that it is lower than the light intensity in the typical image forming operation.

FIG. 14 is an explanatory view illustrating a current program period and an organic electroluminescence device lightening on/off period related to the exposure device 13 in the image forming apparatus 1 according to the second embodiment of the invention.

Hereinafter, a lightening on/off control according to the second embodiment will be described in more detail with reference to FIG. 14 in conjunction with FIG. 13. In the following description, it is assumed that 8 pixels forms one group (for example, “pixel numbers in a main scan direction” are 1 to 8 as shown in FIG. 14) for the sake of simplification of description.

In the second embodiment, one line period (raster period) of the exposure device 13 is set to be 350 μs, and ⅛ (43.75 μs) of the one line period is set as a program period at which a driving current value is set for the condenser formed in the current program part 71.

First, the gate controller 68 (see FIG. 13) sets a program period for a pixel No. 1 with the SCAN_A signal set to be ON and the SCAN_B signal set to be OFF. During the program period, the 8-bit light intensity correction data is supplied to the D/A converter 72 of the source driver 61 (see FIG. 13), and the condenser of the current program part 71 (see FIG. 13) is charged by an analog level signal into which the supplied light intensity correction data is D/A-converted. This program period is executed with no relation to ON/OFF of the binary image data inputted to the gate controller 68. Accordingly, an analog value based on the 8-bit light intensity correction data (ND[n] shown in FIG. 11 in the image forming operation, and a product of DD[n] shown in FIG. 11 and a constant k smaller than 1 in the light intensity measuring operation) is written into the condenser of the current program part 71 every line period. That is, charges accumulated in the condenser of the current program part 71 is refreshed at all times, thereby maintaining the driving current of the organic electroluminescence device 110 at all times.

After the program period is completed, the gate controller 68 (see FIG. 13) sets a lightening period by switching the SCAN_A signal to be OFF and the SCAN_B signal to be ON. As described above, in the image forming operation, the gate controller 68 (see FIG. 13) is supplied with the binary image data generated in the light intensity measuring operation, and the organic electroluminescence devices 110 are not lightened on if the image data is in an OFF state even during a lightening period. On the other hand, if the image data is in an ON state, the organic electroluminescence devices 110 continue to be lightened on during a remaining period of 306.25 μs (350 μs−43.75 μs) (actually, an emission period becomes somewhat shorter since there exists a switching time of the control signal). As described above, in the second embodiment, since it is assumed that a measurement time of the light intensity of the organic electroluminescence devices 110 is 30 ms, the controller 41 generates the dummy image information such that the number of times of lightening in the light intensity measurement operation is, for example, 100 (that is, 100 lines).

On the other hand, after the program period for the pixel circuit 69 (see FIG. 13) of the pixel No. 1 is completed, the gate controller 68 (see FIG. 13) sets a current program period for a pixel circuit 69 (see FIG. 13) of a pixel No. 8. Thereafter, like the pixel circuit of the pixel. No. 1, after the program period for the pixel circuit of the pixel. No. 8 is completed, a lightening period of the organic electroluminescence devices 110 (see FIG. 13) of the pixel number is executed.

In this manner, the gate controller 68 (see FIG. 13) sets the program period and the lightening period in an order of pixel numbers “1→8→2→7→3→6→4→5→1 . . . ” in the main scan direction. According to such a lightening order, since lightening timings of pixels closest to each other in a group of adjacent pixels are temporarily close to each other, an image step may be inconspicuous in one line formation.

Although it has been illustrated in the second embodiment to control the light intensity of the organic electroluminescence devices 110 by varying the current value of the organic electroluminescence devices 110 of the exposure device 12 while keeping their lightening time constant, the invention can be applied to a PWM system of controlling light intensity of light emitting devices, such as the organic electroluminescence devices 110, by varying lightening time of the light emitting devices while keeping their driving current values constant. In this case, the contents of the first area described with reference to FIG. 11 may be substituted with “the setting values of the driving time to make the latent image cross sections equal to each other.”

In addition, it is known that the an exposure device has a plurality of light emitting device arrays constituted by organic electroluminescence devices or the like and forms a latent image by performing a plurality of exposures at substantially the same position in a rotation direction of a photoconductor. The technical spirit of the invention can be applied to such an exposure device by setting light intensity or a PWM time such that the latent image formed by the plurality of exposures has no effect on developing. Since such an exposure device does not form the latent image that has an effect on the developing in a single light emitting device array, light intensity can be measured in the unit of row in paper interval, for example.

In addition, although it has been illustrated in the second embodiment that the light intensity of the organic electroluminescence devices 13 is measured using the light detecting devices 120 arranged on the glass substrate 100 of the exposure device 13, the technical spirit of the invention is not limited thereto. For example, since low temperature polysilicon composing the TFT circuit 62 has low light transmittance, the light detecting devices 120 corresponding to the organic electroluminescence devices 110 can be embedded in the organic electroluminescence devices 110 even in a so-called bottom emission structure where exposure light is drawn out from a side of the glass substrate 100 described in the second embodiment. In this case, for example, the light detecting devices 120 may be formed on all or some of a surface immediately below a light emitting plane of the organic electroluminescence devices 110.

In addition, a sensor unit constituted by a plurality of sensors that are made of, for example, amorphous silicon and are arranged in the form of a film may be attached to an end side of the glass substrate 100 of the exposure device 13 and reflected light that propagates inside the glass substrate 100 may be measured by means of the sensor unit. The technical spirit of the invention can be also applied to such configuration.

Although the image forming apparatus employing the electrophotography method has been illustrated in the second embodiment, the invention is not limited to the electrophotography method. Since an RGB light source can be realized by organic electroluminescence devices without difficulty, it goes without saying that the invention can be applied to an image forming apparatus where a plurality of exposure devices having an R light source, a G light source and a B light source as exposure light sources are arranged and a printing paper is directly exposed to light based on image data for each of RGB colors.

### Third Embodiment

FIGS. 15A and 15B are explanatory views illustrating examples of device arrangement in an exposure device according to a third embodiment of the invention.

Hereinafter, a modification of device arrangement according to a third embodiment of the invention will be described.

Although the select transistors 130, the capacitive elements 140 and the light detecting devices 120 are arranged in a line in a direction substantially perpendicular to the light emitting device array in the first embodiment (see FIG. 1) as shown in FIG. 15A, the capacitive elements 140 may be arranged to be deviated from the select transistors 130 and the light detecting devices 120 in zigzags as shown in FIG. 15B. Here, a reference numeral 110 denotes organic electroluminescence devices.

In addition, although it has been illustrated in the above embodiment to use the light detecting devices 120 constituted by TFTs, the invention can be applied to light detecting devices having different structures, such as an image sensor having a sandwich structure where an amorphous silicon layer or polycrystalline silicon layer is sandwiched between a pair of electrodes, without limiting the light detecting devices 120 to TFTs.

### Fourth Embodiment

FIGS. 16A, 16B and 16C are explanatory views illustrating examples of device arrangement in an exposure device according to a fourth embodiment of the invention.

Although it has been illustrated in the above-described embodiments that the light detecting devices 120 are in a one-to-one correspondence to the organic electroluminescence devices 110, as shown in FIG. 16A, to detect data precisely, instead, a two-to-one correspondence or a n-to-one correspondence may be also effective.

As a modification, the light detecting devices 120 may be in a two-to-one correspondence to the organic electroluminescence devices 110, as shown in FIG. 16B. With this configuration, the number of light detecting circuits can be reduced to a half by arranging one light detecting device in correspondence to two light emission regions. However, in this case, sufficient attention has to be paid to synchronization of switching between the light detecting devices and the organic electroluminescence devices.

As another modification, the light detecting devices 120 may be in an n-to-one correspondence to the organic electroluminescence devices 110 (n is more than 3), as shown in FIG. 16C. With this configuration, the number of light detecting circuits can be significantly reduced by arranging one light detecting device in correspondence to n light emission regions. However, in this case, if there occur defects in the light detecting devices, light intensity of n organic electroluminescence devices may be improperly corrected. Therefore, sufficient attention has to be paid to extension of unbalance of the light intensity.

In addition, although it has been illustrated in the above embodiments that the light detecting devices 120 detect light emitted from the light emitting devices in the exposure device, the technical spirit of the invention can be applied to an image sensor used in a scanner, for example. Specifically, it may be configured to include a light detecting device array constituted by a plurality of light detecting devices, capacitive elements connected in parallel to the light detecting devices, and select transistors for switching that are connected to the capacitive elements and control read of charges accumulated in the capacitive elements, with the select transistors and the light detecting devices isolated from each other with the capacitive elements interposed therebetween. In an embodiment employing the image sensor, since the light detecting devices are isolated from the select transistors by the capacitive elements and the capacitive elements are formed in such a manner that two or more electrode layers face each other with an interlayer insulating film interposed therebetween, it is possible to provide high light shielding property and prevent stray light reliably, thereby preventing a malfunction.

### Fifth Embodiment

FIG. 17 is a sectional view of a main portion of an exposure device according to a fifth embodiment of the invention.

FIG. 17 shows a F-F section in FIG. 9.

Hereinafter, a configuration of a portion sealed by the sealing glass 64 will be described in detail with reference to FIG. 17 in conjunction with FIG. 9.

In the following description, various functional components required for exposure, which are formed on the glass substrate 100 of the exposure device, are collectively called “optical head body” for convenience' sake.

As shown in FIGS. 9 and 17, the optical head body is formed by integrating a light detecting device 120, a light intensity detecting circuit C (see the top view shown in FIG. 1), an organic electroluminescence device 110 as a light emitting device, and a driving circuit 169 on the glass substrate 100. A select transistor 130 for switching, which is a part of the light detecting circuit C, is formed on an edge of the glass substrate 100. In addition, in the fifth embodiment, the organic electroluminescence device 110 overlaps the light detecting device 120.

In addition, at least the select transistor 130 which is formed on the edge of the glass substrate 100 is coated with an adhesive 63 through which the sealing glass 64 is adhered to the select transistor 130. Of course, the light intensity detecting circuit C may be also coated with the adhesive 63, as shown in FIG. 17.

In a dicing process of forming a plurality of optical head bodies on large mother glass (which will be described below) and cutting out the plurality of optical head bodies individually, if there occur cracks in the glass substrate 100, a semiconductor layer made of polycrystalline silicon composing a TFT may be peeled off or deteriorated, thereby deteriorating a device characteristic. However, with the configuration using the adhesive 63, the adhesive 63 reliably protects the semiconductor layer that lies below the adhesive 63, thereby improving reliability of the device.

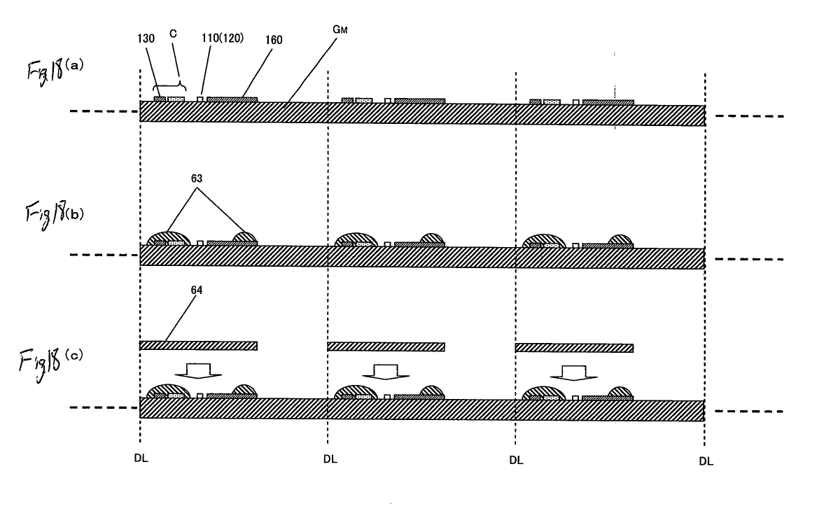

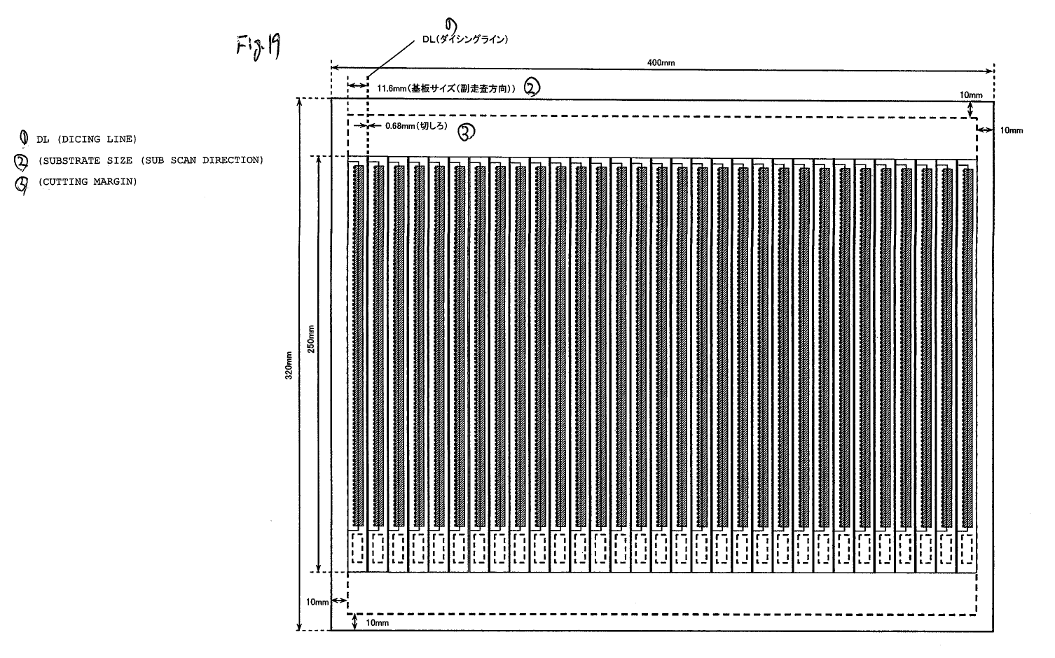

FIGS. 18A, 18B and 18C are explanatory views illustrating a manufacturing process of the exposure device according to the fifth embodiment of the invention.

Hereinafter, a manufacturing process of the exposure device, particularly, a (dicing) process of cutting out glass substrates 100 from mother glass G_{M} individually, will be described with reference to FIGS. 9, 17 and 18A to 18C.

In manufacturing the exposure device, components such as the light intensity detecting circuit C including the select transistor 130, the light detecting device 120, the organic electroluminescence device 110, the driving circuit 160 and so on are formed by forming a polycrystalline silicon layer on a glass mother material, that is, the mother glass G_{M}, performing patterning and doping processes for the polycrystalline silicon layer, and forming an insulating film and a conductive film such as a metal film, as shown in FIG. 18A.

Thereafter, a region of the light intensity detecting circuit C including the select transistor 130 is coated with the adhesive 63, as shown in FIG. 18B. At this time, it is preferable that this region coated by the adhesive 63 is isolated by 0.5 mm or so from a dicing line DL so that the region does not contact a blade of a dicing saw during the dicing process. In addition, the adhesive 63 is coated to surround the optical head body, as shown in FIG. 9, and then, the sealing glass 64 is mounted thereon, as shown in FIG. 18C.

After the sealing glass 64 is mounted, the mother glass G_{M} is divided into a plurality of optical head bodies at a position of the dicing line DL.

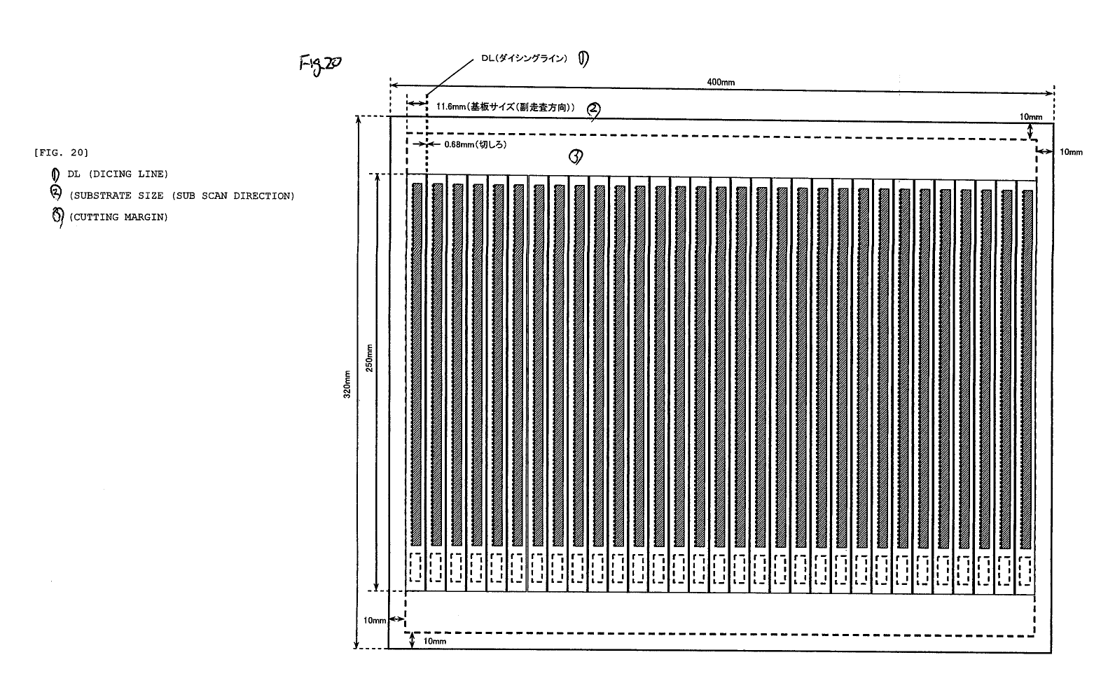

FIG. 19 is a top view of the mother glass according to the fifth embodiment of the invention.

As shown in FIG. 19, the dicing process is performed along the dicing line DL to divide the mother glass into a plurality of optical head bodies. Although FIG. 19 shows one dicing line DL for the sake of avoiding complexity, all of the shown optical head bodies are cut out in an actual dicing process.

Cracks are apt to occur at a portion of the dicing line DL due to stress produced in the dicing process, however, since the light intensity detecting circuit C including the select transistor 130 is coated with the adhesive 63, even if the cracks occur, it is possible to suppress the cracks from progressing at a region coated with the adhesive 63 and protect the light intensity detecting circuit C by means of the adhesive 63, thereby improving reliability of the device. In addition, when the sealing glass 64 is mounted, since the light intensity detecting circuit C is coated with the adhesive 63, stress produced when the sealing glass 64 is mounted may be reduced, thereby preventing cracks from occurring.

FIG. 20 is a top view of the mother glass according to the fifth embodiment of the invention.

Although it is shown in FIG. 19 that the mother glass is divided into the plurality of optical head bodies by performing the dicing process after the sealing glass 64 is mounted, the sealing glass 64 may be mounted after the division, without mounting the sealing glass 64 at a point of time of dicing, as shown in FIG. 20. In this case, a hot melting resin material may be used as the adhesive 63, and, after the sealing glass 64 is coated with the adhesive 63, the dicing process may be performed while heating and compressing the sealing glass 64 and the adhesive 63 together.

Since an edge of the glass substrate 100, that is, an arrangement region of the light intensity detecting circuit C, is covered with the adhesive 63, cracks are suppressed from progressing in the dicing process. In addition, when the sealing glass 64 is mounted, since the light intensity detecting circuit C including the select transistor 130 is also covered with the adhesive 63, stress produced when the sealing glass 64 is mounted may be reduced, thereby preventing cracks from occurring.

In addition, although the adhesive 63 is formed in a line in the above description, the adhesive 63 may be coated to correspond to the entire region of the sealing glass 64 (beta sealing), or, without using the sealing glass 64, a laminate film constituted by a stack structure including metal and resin may seal the adhesive 63 (thin film sealing).

In addition, in order to reduce stress produced when the dicing process is performed, it is preferable that the adhesive 63 is isolated by more than 0.5 mm from the edge of the glass substrate 100. With this configuration, a region at the edge not coated with the adhesive 63 becomes a stress reduction region that suppresses cracks from occurring in the dicing process. In addition, even when cracks occur in this region, the cracks are suppressed from progressing in the adhesive 63, thereby improving reliability of the device.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

Various exposure devices related to the present invention and the image forming apparatus that employs the same can be used for printers, copiers, facsimile machines, photo printers, etc.

This application is based upon and claims the benefit of priority of Japanese Patent Application No 2006-100412 filed on 2006 Mar. 31, Japanese Patent Application No 2006-100413 filed on 2006 Mar. 31, Japanese Patent Application No 2006-100414 filed on 2006 Mar. 31, Japanese Patent Application No 2006-100415 filed on 2006 Mar. 31, the contents of which are incorporated herein by reference in its entirety.

1. An exposure device comprising:
a substrate;
a light emitting device array including a plurality of light emitting devices arranged on the substrate;
a light detecting device that detects light emitted from the light emitting devices;
a switching device that selects the light detecting devices and draws out an output from the light detecting devices; and
a light shielding unit interposed between the light detecting devices and the switching device.

2. The exposure device according to claim 1,
wherein the light shielding part is formed of a capacitive element.

3. The exposure device according to claim 1,
wherein the light shielding part and the switching device are arranged outside a light emitting region of the light emitting devices.

4. The exposure device according to claim 3,
wherein the light shielding part and the switching device are arranged along the light emitting device array.

5. The exposure device according to claim 1,
wherein the light shielding part and the switching device are respectively arranged in a one-to-one correspondence to the light emitting devices included in the light emitting device array.

6. An exposure device comprising:
a substrate;
a light emitting device array including a plurality of light emitting devices arranged on the substrate;
a light detecting device that detects light emitted from the light emitting devices; and
a light intensity detecting unit that processes an output of the light detecting device,
wherein the light intensity detecting unit includes a capacitive element connected to the light detecting device and a select transistor that is connected to the capacitive element and draws out charges accumulated in the capacitive element, and
wherein the select transistor and the light detecting device are isolated from each other with the capacitive element interposed therebetween.

7. The exposure device according to claim 6,
wherein the select transistor, the capacitive element and the light detecting device are arranged in order in a direction substantially perpendicular to an direction of the light emitting device array.

8. The exposure device according to claim 6, further comprising a driving unit including a driving transistor connected to a driving electrode of the light emitting devices on the substrate,
wherein the driving unit and the light intensity detecting unit is isolated from each other with the light emitting device array interposed therebetween.

9. The exposure device according to claim 6,
wherein an electroluminescence device as the light emitting devices, the electroluminescence device including a first electrode, a second electrode and a light emitting layer interposed therebetween, overlaps the light detecting device including a photoelectric converting layer that detects light emitted from the electroluminescence device, and
wherein the driving unit including the driving transistor connected to the first or second electrode of the electroluminescence device is isolated from the light intensity detecting unit connected to the output of the light detecting device with the light emitting device array interposed therebetween.

10. The exposure device according to claim 9,
wherein the light detecting device includes a thin film transistor having a gate electrode formed at a side of the light detecting device of the electroluminescence device

11. The exposure device according to claim 10,
wherein the select transistor of the light intensity detecting unit is a transistor including a semiconductor thin film used as a device region, the semiconductor thin film being formed by the same process as the thin film transistor included in the light detecting device.

12. The exposure device according to claim 10,
wherein the driving transistor of the driving unit is a transistor including a semiconductor thin film used as a device region, the semiconductor thin film being formed by the same process as the thin film transistor included in the light detecting device.

13. The exposure device according to claim 9,
wherein the light detecting device, the electroluminescence device, the capacitive element of the light intensity detecting unit, the select transistor for switching, and the driving transistor of the driving unit are circuit devices integrated on the same substrate.

14. The exposure device according to claim 9,
wherein the electroluminescence device is an organic electroluminescence device using an organic semiconductor layer as the light emitting layer.

15. The exposure device according to claim 9,
wherein the electroluminescence device is an inorganic electroluminescence device using an inorganic semiconductor layer as the light emitting layer.

16. The exposure device according to claim 9, further comprising a light intensity correcting unit that corrects light intensity of the electroluminescence device based on the output of the light detecting device.

17. The exposure device according to claim 6,
wherein the light detecting device is stacked on each of the plurality of light emitting devices arranged on the substrate.

18. The exposure device according to claim 17,
wherein one light detecting device is arranged to correspond to one light emitting device.

19. The exposure device according to claim 17,
wherein the light detecting device is arranged to correspond to two or more light emitting devices.

20. An image forming apparatus using an exposure device according to claim 1 as an exposure light source for image formation.
